(19) United States
(12) Patent Application Publication
(10) Pub. No.: US 2013/0236607 A1
(43) Pub. Date: Sep. 12, 2013

(54) DAILY MEAL PLANS AND CONTAINERS FOR THE SAME

(71) Applicants: Reinhard Rye, Manhattan Beach, CA (US); Phil Sims, London (GB); Elizabeth Ann Applegate, Davis, CA (US)

(72) Inventors: Reinhard Rye, Manhattan Beach, CA (US); Phil Sims, London (GB); Elizabeth Ann Applegate, Davis, CA (US)

(73) Assignee: ON FOOD, INC., Beverly Hills, CA (US)

(21) Appl. No.: 13/640,450

(22) PCT Filed: Apr. 12, 2010
(86) PCT No.: PCT/US2010/030779

§ 371 Date: May 22, 2013

(51) Int. Cl. A23L 1/29; B65D 77/04

(52) U.S. Cl. CPC A23L 1/296; B65D 77/04
USPC 426/87; 426/124

(57) ABSTRACT

A container for a prepackaged dietary daily meal plan comprises a hollow body portion. Individually prepackaged containers are configured to be received within the hollow body portion. The individually prepackaged containers each comprise an edible component of a dietary daily meal plan and each of the edible components has a predetermined caloric content. The edible components together provide a predetermined daily caloric content. The individually prepackaged containers comprise a first individually prepackaged container comprising a first edible component having a first caloric content (A), a second individually prepackaged container comprising a second edible component having a second caloric content (B), a third individually prepackaged container comprising a third edible component having a third caloric content (C), and a fourth individually prepackaged container comprising a fourth edible component having a fourth caloric content (D). The predetermined daily caloric content (E) is determined by the following relationship: E≧A+B+C+D.

### FIELD

The present disclosure generally relates to daily meal plans and, more particularly, relates to daily meal plans and containers for the same.

### BACKGROUND

In today's demanding society, individuals are frequently unable to find or make the time to consistently plan and prepare nutritious meals and, often, many consumers turn to fast food or other unhealthy meal alternatives. As a result, many individuals find themselves in need of a meal plan that provides nutritiously complete meals that are easy to use and prepare. In recent years, prepackaged meals have increased in popularity. These prepackaged meals may contain a variety of ready-to-eat food items chosen to provide an essentially complete meal that may include both main dishes and side dishes. As convenient as prepackaged meals may be, however, consumers must still plan their desired daily nutritional requirements and select individual meals that when combined meet their desired daily nutritional requirements. Additionally, current prepackaged meals often require individuals to prepare supplemental items to complement the prepackaged meals. In view of the importance of prepackaged meals and food items in today's society, this technology should be improved.

### SUMMARY

In one embodiment, the present disclosure is directed, in part, to a container for a prepackaged dietary daily meal plan. The container comprises a hollow body portion and individually prepackaged containers configured to be received within the hollow body portion. Each of the individually prepackaged containers comprises an edible component of a dietary daily meal plan and each of the edible components has a predetermined caloric content. The edible components together provide a predetermined daily caloric content (E) when consumed. The individually prepackaged containers comprise a first individually prepackaged container comprising a first edible component having a first caloric content (A), a second individually prepackaged container comprising a second edible component having a second caloric content (B), a third individually prepackaged container comprising a third edible component having a third caloric content (C), and a fourth individually prepackaged container comprising a fourth edible component having a fourth caloric content (D). The predetermined daily caloric content (E) is determined by the following relationship: E≧A+B+C+D.

In one embodiment, the present disclosure is directed, in part, to a dietary daily meal plan prepackaged in a container comprising a hollow body portion comprising at least one aperture along a longitudinal length thereof. The dietary daily meal plan comprises a plurality of individually prepackaged containers each comprising an edible component of a dietary daily meal plan. The edible components each have a predetermined nutritional content of a nutrient component. The edible components of each of the individually prepackaged containers together provide a predetermined daily nutritional content (E) of the nutrient component when consumed. The individually prepackaged containers comprise a first individually prepackaged container comprising a first edible component having a first nutritional content (A) of the nutrient component, a second individually prepackaged container comprising a second edible component having a second nutritional content (B) of the nutrient component, a third individually prepackaged container comprising a third edible component having a third nutritional content (C) of the nutrient component, a fourth individually prepackaged container comprising a fourth edible component having a fourth nutritional content (D) of the nutrient component, and a fifth individually prepackaged container comprising a fifth edible component having a fifth nutritional content (F) of the nutrient component. The predetermined daily nutritional content (E) of the nutrient component is the sum of the first, second, third, fourth, and fifth nutritional contents (A, B, C, D, and F) of the nutrient component of the corresponding first, second, third, fourth, and fifth edible components contained in the corresponding first, second, third, fourth, and fifth individually prepackaged containers. The predetermined daily nutritional content (E) of the nutrient component is determined by the following relationship: E=A+B+C+D+F.

In one embodiment, the present disclosure is directed, in part, to a container for a prepackaged daily meal plan. The container comprises a hollow body portion and a plurality of prepackaged containers. Each of the prepackaged containers comprises edible content therein. The prepackaged containers are positioned within the hollow body portion and each of the prepackaged containers comprises indicia to indicate the nutritional and caloric content of the edible content contained therein. The hollow body portion comprises at least one aperture along a longitudinal length thereof. The aperture comprises a first end, a second end, a first side wall extending between the first end and the second end, and a second side wall extending between the first end and the second end. A longitudinal axis is defined between the first end and the second end and a lateral axis is defined between a midpoint of the first side wall and a midpoint of the second side wall. A first quadrant is defined on a first side of the longitudinal axis and a first side of the lateral axis. A second quadrant is defined on the first side of the longitudinal axis and a second side of the lateral axis. A third quadrant is defined on a second side of the longitudinal axis and the first side of the lateral axis. A fourth quadrant is defined on the second side of the longitudinal axis and the second side of the lateral axis. A first arcuate portion forms a portion of the aperture in the first quadrant. A second arcuate portion forms a portion of the aperture in the second quadrant. A third arcuate portion forms a portion of the aperture in the third quadrant. A fourth arcuate portion forms a portion of the aperture in the fourth quadrant.

### BRIEF DESCRIPTION OF THE DRAWINGS

The example embodiments described herein will become more apparent and will be better understood by reference to the following description of non-limiting embodiments of the disclosure taken in conjunction with the accompanying drawings, wherein:

FIG. 1 is a front perspective view of a container comprising a prepackaged daily meal plan in accordance with one non-limiting embodiment;

FIG. 2 is a rear perspective view of the container comprising a prepackaged daily meal plan of FIG. 1 in accordance with one non-limiting embodiment;

FIG. 3 is a front view of the container comprising a prepackaged daily meal plan of FIG. 1 in accordance with one non-limiting embodiment;

FIG. 4 is a rear view of the container comprising a prepackaged daily meal plan of FIG. 1 in accordance with one non-limiting embodiment;

FIG. 5 is a left side view of the container comprising a prepackaged daily meal plan of FIG. 1 in accordance with one non-limiting embodiment;

FIG. 6 is a right side view of the container comprising a prepackaged daily meal plan of FIG. 1 in accordance with one non-limiting embodiment;

FIG. 7 is a top view of the container comprising a prepackaged daily meal plan of FIG. 1 in accordance with one non-limiting embodiment;

FIG. 8 is a bottom view of the container comprising a prepackaged daily meal plan of FIG. 1 in accordance with one non-limiting embodiment;

FIG. 9 is a partially cut away view of the container of FIG. 1 illustrating an aperture of the container in accordance with one non-limiting embodiment;

FIG. 10 is a top view of an unfolded container configured to comprise a prepackaged daily meal plan in accordance with one non-limiting embodiment;

FIG. 11 is a perspective view of the unfolded container of FIG. 10 in accordance with one non-limiting embodiment;

FIG. 12 is a partial cut away view of a container comprising a prepackaged daily meal plan in accordance with one non-limiting embodiment;

FIG. 13 is a partial cut away view of the container of FIG. 12 with the prepackaged daily meal plan removed in accordance with one non-limiting embodiment;

FIG. 14 is a perspective view of an individually prepackaged container used in a prepackaged daily meal plan in accordance with one non-limiting embodiment;

FIG. 15 is a side view of the individually prepackaged container of FIG. 14 in accordance with one non-limiting embodiment;

FIG. 16 is a perspective view of an individually prepackaged container used in a prepackaged daily meal plan in accordance with one non-limiting embodiment;

FIG. 17 is a perspective view of an individually prepackaged container used in a prepackaged daily meal plan in accordance with one non-limiting embodiment;

FIG. 18a is a perspective view of a pill pack position on or attached to an individually prepackaged container in accordance with one non-limiting embodiment;

FIG. 18b is a perspective view of a collapsible utensil positioned on or attached to an individually prepackaged container in accordance with one non-limiting embodiment;

FIG. 19 is a perspective view of the collapsible utensil of FIG. 18 in a collapsed position in accordance with one non-limiting embodiment;

FIGS. 20a and 20b are perspective views of the collapsible utensil of FIG. 18 in partially collapsed positions in accordance with one non-limiting embodiment;

FIG. 21 is a perspective view of a collapsible utensil in a non-collapsed position in accordance with one non-limiting embodiment;

FIG. 22 is a nutrient profile for a 1,200 Calorie level prepackaged daily meal plan in accordance with one non-limiting embodiment;

FIG. 23 is a nutrient profile for a 1,200 Calorie level prepackaged daily meal plan in accordance with one non-limiting embodiment;

FIG. 24 is a nutritional table for apple cinnamon oatmeal for a 1,200 Calorie level prepackaged daily meal plan breakfast in accordance with one non-limiting embodiment;

FIG. 25 is a nutritional table and an ingredient list for apple cinnamon oatmeal for a 1,200 Calorie level prepackaged daily meal plan breakfast in accordance with one non-limiting embodiment;

FIG. 26 is a nutritional table and an ingredient list for peach oatmeal for a 1,200 Calorie level prepackaged daily meal plan breakfast in accordance with one non-limiting embodiment;

FIG. 27 is a nutritional table for chicken vegetable and rice soup for a 1,200 Calorie level prepackaged daily meal plan early lunch in accordance with one non-limiting embodiment;

FIG. 28 is a nutritional table and an ingredient list for chicken with vegetables, brown rice and teriyaki sauce for a 1,200 Calorie level prepackaged daily meal plan early lunch in accordance with one non-limiting embodiment;

FIG. 29 is a nutritional table and an ingredient list for chicken with vegetables, brown rice and teriyaki sauce for a 1,200 Calorie level prepackaged daily meal plan early lunch in accordance with one non-limiting embodiment;

FIG. 30 is a nutritional table for chicken with wok vegetables and brown rice for a 1,200 Calorie level prepackaged daily meal plan late lunch in accordance with one non-limiting embodiment;

FIG. 31 is a nutritional table and an ingredient list for lemon dill albacore tuna with shells for a 1,200 Calorie level prepackaged daily meal plan late lunch in accordance with one non-limiting embodiment;

FIG. 32 is a nutritional table and an ingredient list for lemon dill albacore tuna with shells for a 1,200 Calorie level prepackaged daily meal plan late lunch in accordance with one non-limiting embodiment;

FIG. 33 is a nutritional table for southwest chicken and corn chowder for a 1,200 Calorie level prepackaged daily meal plan dinner in accordance with one non-limiting embodiment;

FIG. 34 is a nutritional table and an ingredient list for chicken marinara with penne for a 1,200 Calorie level prepackaged daily meal plan dinner in accordance with one non-limiting embodiment;

FIG. 35 is a nutritional table and an ingredient list for penne and marinara sauce with chicken for a 1,200 Calorie level prepackaged daily meal plan dinner in accordance with one non-limiting embodiment;

FIG. 36 is a nutritional table and an ingredient list for a dulce de leche bar for a 1,200 Calorie level prepackaged daily meal plan snack in accordance with one non-limiting embodiment;

FIG. 37 is a nutrient profile for a 1,600 Calorie level prepackaged daily meal plan in accordance with one non-limiting embodiment;

FIG. 38 is a nutrient profile for a 1,600 Calorie level prepackaged daily meal plan in accordance with one non-limiting embodiment;

FIG. 39 is a nutritional table for peach oatmeal for a 1,600 Calorie level prepackaged daily meal plan breakfast in accordance with one non-limiting embodiment;

FIG. 40 is a nutritional table and an ingredient list for apple cinnamon oatmeal for a 1,600 Calorie level prepackaged daily meal plan breakfast in accordance with one non-limiting embodiment;

FIG. 41 is a nutritional table and an ingredient list for apple cinnamon oatmeal for a 1,600 Calorie level prepackaged daily meal plan breakfast in accordance with one non-limiting embodiment;

FIG. 42 is a nutritional table for chicken vegetable and rice soup for a 1,600 Calorie level prepackaged daily meal plan early lunch in accordance with one non-limiting embodiment;

FIG. 43 is a nutritional table and an ingredient list for chicken with vegetables, brown rice and teriyaki sauce for a 1,600 Calorie level prepackaged daily meal plan early lunch in accordance with one non-limiting embodiment;

FIG. 44 is a nutritional table and an ingredient list for chicken with vegetables, brown rice and teriyaki sauce for a 1,600 Calorie level prepackaged daily meal plan early lunch in accordance with one non-limiting embodiment;

FIG. 45 is a nutritional table for chicken with marinara penne for a 1,600 Calorie level prepackaged daily meal plan late lunch in accordance with one non-limiting embodiment;

FIG. 46 is a nutritional table and an ingredient list for southwest style chicken corn chowder for a 1,600 Calorie level prepackaged daily meal plan late lunch in accordance with one non-limiting embodiment;

FIG. 47 is a nutritional table and an ingredient list for southwest style chicken corn chowder for a 1,600 Calorie level prepackaged daily meal plan late lunch in accordance with one non-limiting embodiment;

FIG. 48 is a nutritional table for chicken with wok vegetables and brown rice for a 1,600 Calorie level prepackaged daily meal plan dinner in accordance with one non-limiting embodiment;

FIG. 49 is a nutritional table and an ingredient list for beef minestrone soup for a 1,600 Calorie level prepackaged daily meal plan dinner in accordance with one non-limiting embodiment;

FIG. 50 is a nutritional table and an ingredient list for beef minestrone soup for a 1,600 Calorie level prepackaged daily meal plan dinner in accordance with one non-limiting embodiment;

FIG. 51 is a nutritional table and an ingredient list for a coca mocha bar for a 1,600 Calorie level prepackaged daily meal plan snack in accordance with one non-limiting embodiment;

FIG. 52 is a nutrient profile for a 2,000 Calorie level prepackaged daily meal plan in accordance with one non-limiting embodiment;

FIG. 53 is a nutrient profile for a 2,000 Calorie level prepackaged daily meal plan in accordance with one non-limiting embodiment;

FIG. 54 is a nutritional table for corned beef hash for a 2,000 Calorie level prepackaged daily meal plan breakfast in accordance with one non-limiting embodiment;

FIG. 55 is a nutritional table and an ingredient list for maple brown sugar oatmeal for a 2,000 Calorie level prepackaged daily meal plan breakfast in accordance with one non-limiting embodiment;

FIG. 56 is a nutritional table and an ingredient list for maple brown sugar oatmeal for a 2,000 Calorie level prepackaged daily meal plan breakfast in accordance with one non-limiting embodiment;

FIG. 57 is a nutritional table for chicken salsa with beans and rice for a 2,000 Calorie level prepackaged daily meal plan early lunch in accordance with one non-limiting embodiment;

FIG. 58 is a nutritional table and an ingredient list for penne beef Bolognese for a 2,000 Calorie level prepackaged daily meal plan early lunch in accordance with one non-limiting embodiment;

FIG. 59 is a nutritional table and an ingredient list for penne beef Bolognese for a 2,000 Calorie level prepackaged daily meal plan early lunch in accordance with one non-limiting embodiment;

FIG. 60 is a nutritional table for chicken with wild and brown rice soup for a 2,000 Calorie level prepackaged daily meal plan late lunch in accordance with one non-limiting embodiment;

FIG. 61 is a nutritional table and an ingredient list for chicken vindaldoo with vegetables and brown rice for a 2,000 Calorie level prepackaged daily meal plan late lunch in accordance with one non-limiting embodiment;

FIG. 62 is a nutritional table and an ingredient list for chicken vindaldoo with vegetables and brown rice for a 2,000 Calorie level prepackaged daily meal plan late lunch in accordance with one non-limiting embodiment;

FIG. 63 is a nutritional table for chicken with wok vegetables and brown rice for a 2,000 Calorie level prepackaged daily meal plan dinner in accordance with one non-limiting embodiment;

FIG. 64 is a nutritional table and an ingredient list for chili beans in sauce with turkey for a 2,000 Calorie level prepackaged daily meal plan dinner in accordance with one non-limiting embodiment;

FIG. 65 is a nutritional table and an ingredient list for three bean chili with turkey for a 2,000 Calorie level prepackaged daily meal plan dinner in accordance with one non-limiting embodiment;

FIG. 66 is a nutritional table for a dulce de leche bar for a 2,000 Calorie level prepackaged daily meal plan snack in accordance with one non-limiting embodiment;

FIG. 67 is a nutritional table and an ingredient list for a coca mocha bar for a 2,000 Calorie level prepackaged daily meal plan snack in accordance with one non-limiting embodiment;

FIG. 68 is a nutrient profile for a 2,400 Calorie level prepackaged daily meal plan in accordance with one non-limiting embodiment; and

FIG. 69 is nutrient profile for a pill pack in accordance with one non-limiting embodiment.

### DETAILED DESCRIPTION

Various non-limiting embodiments of the present disclosure will now be described to provide an overall understanding of the principles of the structure, function, manufacture, and use of the daily meal plans and containers for the same disclosed herein. One or more examples of these non-limiting embodiments are illustrated in the accompanying drawings. It will be appreciated that the daily meal plans and containers for the same specifically described herein and illustrated in the accompanying drawings are non-limiting example embodiments and that the scope of the various non-limiting embodiments of the present disclosure are defined solely by the claims. The features illustrated or described in connection with one non-limiting embodiment may be combined with the features of other non-limiting embodiments. Such modifications and variations are intended to be included within the scope of the present disclosure.

The caloric or nutrient component intake requirements of individuals may vary based on a number of factors, including, for example, activity level and metabolic rate. When caloric or nutrient component intake requirements are exceeded, an individual's body may store the excess calories or nutrient components in adipose tissue. Conversely, when caloric or nutrient component intake requirements are not met, the individual's body may compensate for the negative energy balance by accessing the excess stored calories and nutrient components in adipose tissue within the body as well as undergoing catabolism of muscle protein. In various embodiments, an individual's caloric or nutrient component intake may be derived from four main dietary sources: carbohydrates, proteins, fats, and dietary fiber. Obtaining desirable combinations of these nutrient components sources may be difficult and time consuming for individuals. This is especially the case when an individual may be attempting to lower caloric intake to lose weight using a fad diet, for example. However, individuals often lack the knowledge to properly allocate nutritional components in a reduced Calorie diet. Thus, reduced Calorie diets may, in some circumstances, place individuals at risk for malnutrition. Among the many symptoms of malnutrition are physical and cognitive lethargy, the inability to focus, the lack of memory, and muscle loss, for example.

Typical prepackaged meals may provide convenience and flexibility as to both variety and nutritional combinations. If an individual is to build a diet around prepackaged meals, however, this convenience and flexibility may be accompanied by several drawbacks. First, the individual must determine the caloric content and nutrient component proportions that best fits their daily dietary needs. These daily dietary needs may be influenced by such criteria as lifestyle, weight or nutritional goals, as well as genetics, for example. Second, the individual must determine how best to allocate the caloric content and nutrient component proportions among multiple meals throughout the day. Third, the individual must closely analyze numerous prepackaged meals to find the right combination of caloric content and accompanying nutrient component proportions sufficient to meet their daily requirements or daily dietary requirements.

In view of the foregoing, the present disclosure provides a prepackaged daily meal plan or a prepackaged dietary daily meal plan. In one embodiment, the prepackaged dietary daily meal plan may provide convenience, consistency and flexibility as part of a dietary regimen designed to lose, gain, and/or maintain a particular body weight or fitness level. The prepackaged dietary daily meal plan may be part of an employer sponsored employee health initiative, a nutritional youth program, and/or used by individuals, for example. In other embodiments, the prepackaged dietary meal plan may be packaged in a daily ration manner for ease of tracking and distribution and may be part of a government and/or privately sponsored humanitarian mission, such as caring for the homeless, providing aid to an undeveloped country, and/or uses in disaster relief, for example.

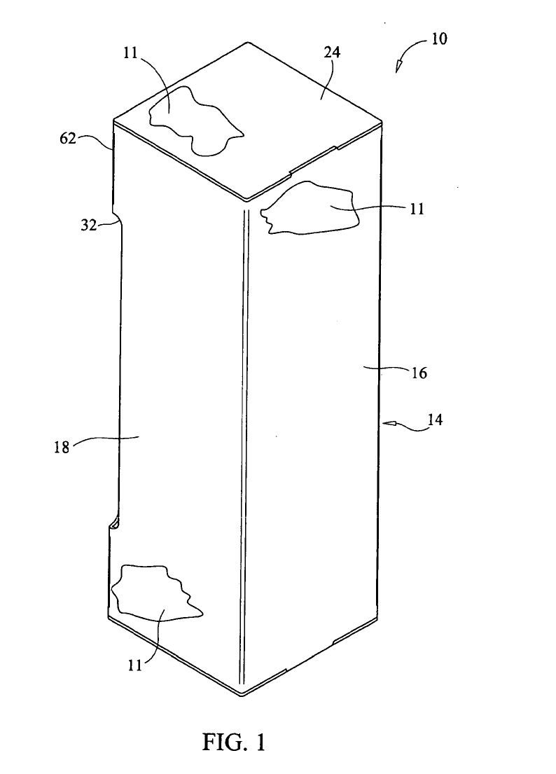

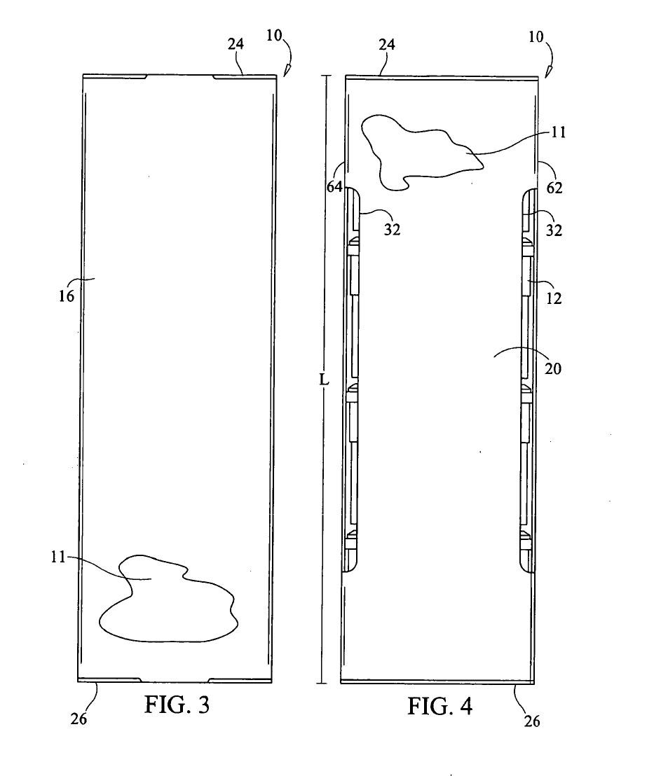

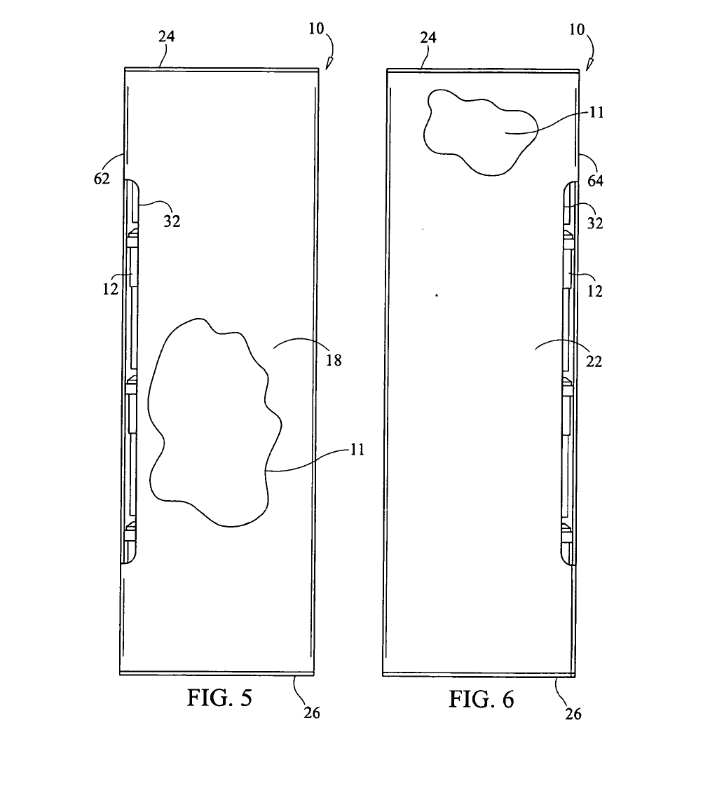

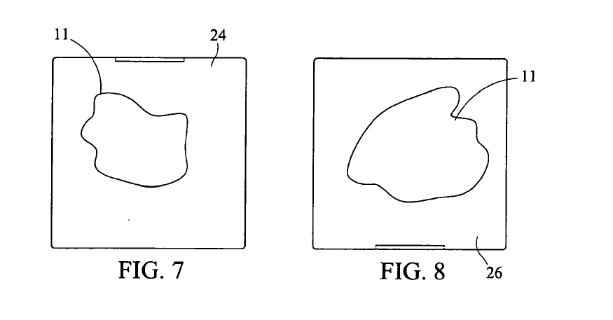

In one embodiment, referring to FIGS. 1-8, a container comprising a prepackaged dietary daily meal plan 10 (hereinafter the “container comprising a prepackaged dietary daily meal plan 10” may be referred to as the “container 10”) may comprise two or more individually prepackaged containers 12 comprising edible components therein, such that a full day of food intake is provided within a single container 10. The two or more individually prepackaged containers 12 may be positioned within a hollow body portion 14 of the container 10. In certain embodiments, the container 10 may be configured to provide a complete, all-in-one, dietary regimen for an individual having nutritional requirements falling within the daily Calorie intake levels described herein (hereinafter “Calorie” may be used to refer to the kilogram calorie, a.k.a. food calorie or kilocalorie (kcal)). That is, absent special circumstance, an individual consuming the container 10 on a daily basis may not require dietary supplementation. This is not to say that an individual may not supplement the container 10 according to specific needs or desires relating to a variation in activity level or other circumstances. In certain embodiments, supplementation may be recommended.

In one embodiment, referring again to FIGS. 1-8, the container 10 may comprise a first side portion or side wall 16, a second side portion or side wall 18, a third side portion or side wall 20, and/or a fourth side portion or side wall 22. In other various embodiments, less or more than four side portions or side walls may be used to provide a container with a different shape or appearance. In various embodiments, the container 10 may comprise a first end portion or top portion 24 and a second end portion or bottom portion 26. In one embodiment, portions of the first and second end portions 24 and 26 may be positioned adjacent to ends of the side portions or side walls 16, 18, 20, and 22 to form a box, for example. The first and second end portions 24 and 26 may each comprise a tab 28 configured to be positioned within a slot 30 formed in one of the side walls or side portions 16, 18, 20, and 22, such as the first side wall 16, for example. The first end portion 24 and/or the second end portion 26 may be movable between a first, open position where the tab 28 is not engaged with the slot 30, and a second, closed position where the tab 28 is engaged with the slot 30 to enclose the hollow body portion 14. In one embodiment, the first and second end portions 24 and 26 may be shaped to fit about a perimeter of ends of the side walls 16, 18, 20, and 22. As such, if four side walls are provided, the first and second end portions 24 and 26 may be square or rectangular to fit over the ends of the side walls 16, 18, 20, and 22. In other embodiment, if three side walls are provided, the first and second end portions may be triangular, for example.

In one embodiment, the first end portion 24 may be used by an individual when accessing or opening the container 10 and the second end portion 26 may generally remain closed to maintain the individually prepackaged containers 12 within the hollow body portion 14 of the container 10. In other embodiments, the second end portion 26 may be used by an individual when accessing or opening the container 10 or both the first end portion 24 and the second end portion 26 may be used. In still other various embodiments, the side walls 16, 18, 20, and 22, the first end portion 24, and/or the second end portion 26 may be ripped or torn to open the container 10 and/or the container 10 may have weakened portions, score marks, and/or perforated portions that may be torn or separated, for example.

In various embodiments, referring again to FIGS. 1-8, the container 10 may comprise one or more apertures 32 configured to allow an individual to view at least one of the individually prepackaged containers 12 within the hollow body portion 14 of the container 10 from outside of the container 10. Stated another way, the apertures 32 may expose portions of the individually prepackaged containers 12. In one embodiment, the one or more apertures 32 may comprise two elongate apertures along a longitudinal length “L” (see e.g., FIG. 4) of the container 10. In various embodiments, the one or more apertures 32 may be formed on some or all of the corners of the container 10 (i.e., where one side wall or side portion intersects another side wall or side portion of the container 10).

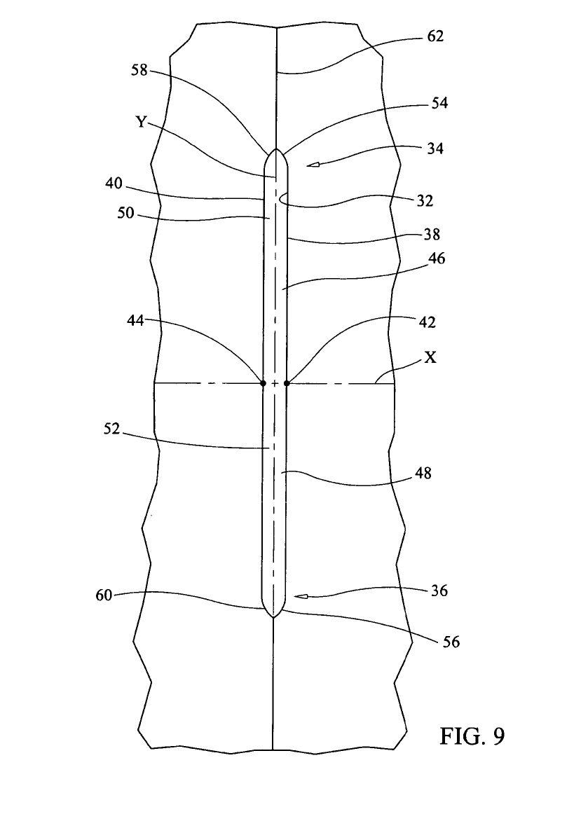

In one embodiment, referring to FIG. 9, the aperture 32 may comprise a first end 34, a second end 36, a first side wall 38 extending between the first end 34 and the second end 36, and a second side wall 40 extending between the first end 34 and the second end 36. A longitudinal axis “Y” may be defined between the first end 34 and the second end 36, while a lateral axis “X” may be defined between a midpoint 42 of the first side wall 38 and a midpoint 44 of the second side wall 40. The aperture 32 may define a first quadrant 46 defined on a first side of the longitudinal axis Y and a first side of the lateral axis X and a second quadrant 48 defined on the first side of the longitudinal axis Y and a second side of the lateral axis X. The aperture 32 may also define a third quadrant 50 defined on a second side of the longitudinal axis Y and the first side of the lateral axis X and a fourth quadrant 52 defined on the second side of the longitudinal axis Y and the second side of the lateral axis X.

In one embodiment, a first arcuate portion 54 may form a portion of the aperture 32 in the first quadrant 46 and a second arcuate portion 56 may form a portion of the aperture 32 in the second quadrant 48. In various embodiments, a third arcuate portion 58 may form a portion of the aperture 32 in the third quadrant 50 and a fourth arcuate portion 60 may form a portion of the aperture 32 in the fourth quadrant 52. In certain embodiments, at least one of the individually prepackaged containers 12 may be exposed through the one or more apertures 32. In various embodiments, the one or more apertures 32 may comprise other various shapes.

In one embodiment, referring back to FIGS. 1-8, the one or more apertures 32 may comprise a first aperture and a second aperture. The first aperture may form a portion of a first corner 62 of the hollow body portion 14 and the second aperture may form a portion of a second corner 64 of the hollow body portion 14. In various embodiments, the first corner 62 may be positioned adjacent to the second corner 64 on the container 10 (see e.g., FIG. 4). In one embodiment, the second aperture may be substantially similar to the first aperture. The first aperture and the second aperture may be at least partially defined in the third side wall 20 of the hollow body portion. In certain embodiments, more than two apertures 32 may be provided. For example, an aperture may be provided on each corner or side wall intersection point on the container 10. In other embodiments, apertures may be provided in the side walls 16, 18, 20, and 22 at locations other than that illustrated in the example embodiments of the various figures and/or in the first end portion 24 and/or the second end portion 26.

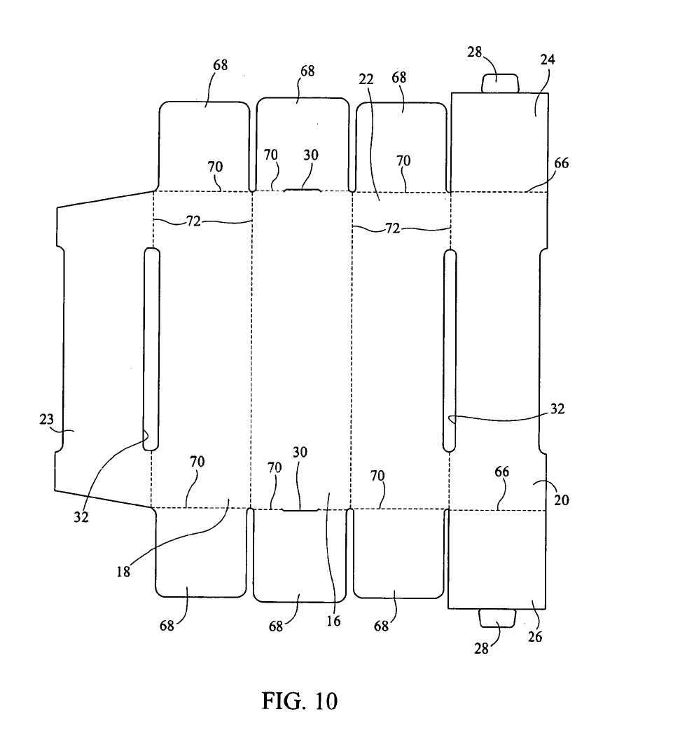

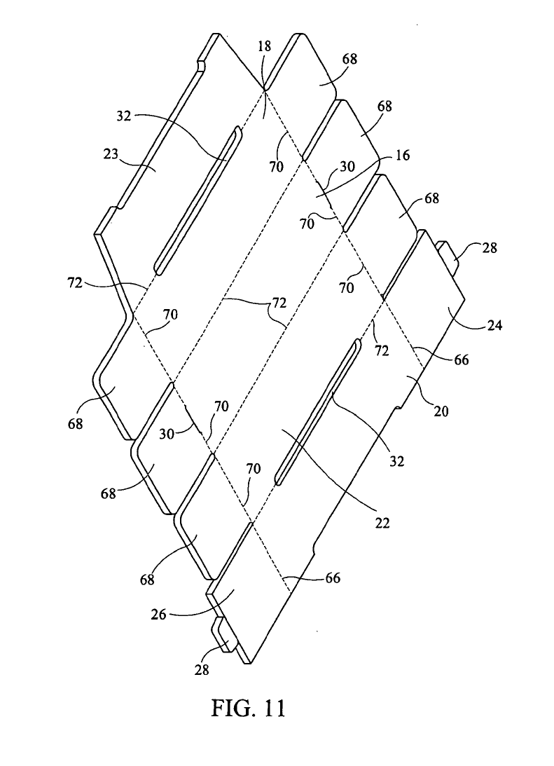

In one embodiment, referring to FIGS. 10 and 11, an unfolded container 10 is illustrated. The container 10 may comprise the first side wall 16, the second side wall 18, the third side wall 20, the fourth side wall 22, and a fifth wall 23. The third side wall 20 may be attached to the first end portion 24 and the second end portion 26. An edge 66 may be defined intermediate the first end portion 24 and the third side wall 20 and intermediate the second end portion 26 and the third side wall 20. In various embodiments, the first, second, and fourth side walls 16, 18, and 22 may be attached to one or more flaps 68. An intersection between the first, second, and fourth side walls 16, 18, and 22 may define edges 70. The first, second, third, and fourth side walls 16, 18, 20, and 22 and the fifth wall 23 may be attached to each other by edges 72. The edges 66, 70, and 72 may comprise weakened portions, perforated portions, scored portions, and/or fold lines which enable folding of the various side walls 16, 18, 20, and 22, the fifth wall 23, the flaps 68, the first end portion 24, and the second end portion 26 about the various edges 66, 70, and 72 to form the container 10. In one embodiment, to form the container 10, the various side walls 16, 18, 20, and 22, and the fifth wall 23 may be folded inwardly to form a rectangular box, for example. An outer surface of the fifth wall 23 may be attached to an inner surface of the third side wall 20 using an adhesive, for example, to maintain the container 10 in the formed state. The flaps 68 may then be folded inwardly into the partially formed container 10 to a position perpendicular to or substantially perpendicular to the planes of the various side walls 16, 18, 20, and 22. The first end portion 24 may then be folded over the top flaps 68 and the tab 28 may be engaged with the slot 30 at the top of the first side wall 16 to maintain the first end portion 24 in a closed position. The second end portion 26 may then be folded over the bottom flaps 68 and the tab 28 may be engaged with the slot 30 at the bottom of the first side wall 16 to maintain the second end portion 26 in a closed position. In other various embodiments, the container 10 may be formed in any other suitable manner. Such other embodiments of forming the container 10 are within the scope of the present disclosure and will be understood by those of skill in the art.

In one embodiment, referring again to FIGS. 1-8, an outside surface or portion of the container 10 may comprise indicia 11. In various embodiments, the indicia 11 may be positioned on all or any of the first side wall 16, the second side wall 18, the third side wall 20, and the fourth side wall 22. The indicia 11 also may be positioned on one or both of the first end portion 24 and the second end portion 26. In one embodiment, the indicia 11 may indicate the caloric content or nutritional content of the edible components within each of the individually prepackaged containers 12 positioned within the container 10. In other embodiments, the indicia 11 may indicate the sum of the caloric content or nutritional content of the edible components within the individually prepackaged containers 12 of the container 10. In various embodiments, the indicia 11 may be color-coded or otherwise coded, for example. In one embodiment, the indicia 11 may comprise photographs or other graphics related to or picturing the edible components within the individually prepackaged container 12 of the container 10.

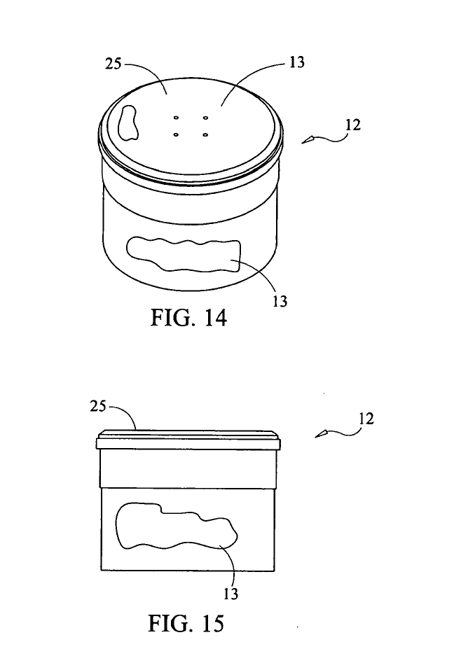

In one embodiment, referring now to FIGS. 14-17 an outside surface or portion of the individually prepackaged containers 12, 12′, and/or 12″ may comprise indicia 13. In various embodiments, the indicia 13 may indicate the caloric content or nutrient content of the edible component or components within each of the individually prepackaged containers 12. In one embodiment, the indicia 13 also may be positioned on a lid 25, a peelable lid 74, and/or on a wrapper (not illustrated) of the individually prepackaged containers 12. The wrapper can be provided to ensure that the individually prepackaged containers 12 remain sterile or at least mostly sterile.

In one embodiment, the indicia 11 or the indicia 13 may use a color coding system. In various embodiments, a color of the indicia 11 may match a color of the indicia 13, for example, to indicate that the container 10 is linked to the individually prepackaged containers 12 positioned therein. The indicia 11 and 13 may correspond to the caloric content of the container 10 or of the edible components of the individually prepackaged containers 12. For example, a green indicia 11 may be associated with a 2,000 Calorie level container 10. In this example embodiment, the indicia 13 on the individually prepackaged containers 12 also may be green. In one embodiment, the color coding system for the indicia 11 and 13 may be presented in any suitable manner or form that enables an individual to identify the color and, therefore, aid the individual in determining the Calorie level of a particular container 10 and/or a particular individually prepackaged container 12. In various embodiments, the indicia 11 and 13 may comprise a colored patch, stripe, and/or band about one or more portions of the container 10 and/or the individually prepackaged containers 12. In other various embodiments, the indicia 11 and 13 may comprise a specific font color, a symbol, a colored symbol, a sticker, and/or any other identifiable indicia. In one embodiment, either in addition to or as a replacement for the color coding, a numbering indicia system may be used with the container 10 and/or the individually prepackaged containers 12, for example. A container 10 having the 1,200 caloric content may be labeled “1”, while a container 10 having the 1,600 caloric content may be labeled ‘2” for example. In other embodiments, a container 10 having the 1,200 caloric content may be labeled “1,200”, while a container 10 having the 1,600 caloric content may be labeled “1,600” for example.

In one embodiment, the 1,200 Calorie level container 10 may be associated with yellow while the 1,600, 2,000, and 2,400 Calorie level daypacks may be respectively associated with red, green, and purple, for example. In other embodiments, the 1,200 Calorie level containers 10 may be associated with tan while the 1,600, 2,000, and 2,400 Calorie level containers 10 may be respectively associated with orange, green, and maroon, for example. The color coding system is not limited in range or tones of colors that may be used. Furthermore, the color coding system may be portrayed or presented in any manner or form that enables a consumer to identify the color coding system and, hence, the Calorie level of a container 10.

In one embodiment, the container 10 may be stored in any suitable environment, such as an environment that is not temperature or moisture controlled, for example. In various embodiments, the container 10 may be stored for an extended period of time without spoilage, thus making the container 10 suitable as an emergency ration in addition to an all-in-one daily meal plan or a daily dietary meal plan. In various embodiments, the prepackaged meals within the container 10 may be consumed heated, unheated, or cooled, for example. Those of ordinary skill in the art will recognize the inherent portability of the container 10 which makes the container 10 easy to consume anywhere.

In various embodiments, referring to FIGS. 14, 15, and 18, the individually prepackaged containers 12 may comprise a general bowl shape with the peelable lid 74 configured to maintain the edible components within the individually prepackaged containers 12 in a sterile condition prior to consumption. The peelable lid 74 may be removed by an individual prior to consumption by pulling on tab 76. In one embodiment, the individually prepackaged containers 12 may comprise the lid 25 positioned thereon. The lid 25 may be removed prior to removal of the peelable lid 74 and then the lid 25 may be repositioned on the individually prepackaged containers 12 such that the individually prepackaged containers 12 may be heated in a microwave without expelling food contents onto the inside of the microwave. Stated another way, the lid 25 may function as a splash guard during heating of the edible components of the individually prepackaged containers 12. In one embodiment, the lid 25 may comprise apertures 78 for venting. In one embodiment, the individually prepackaged containers 12 may be comprised of plastic, paper, STYROFOAM®, and/or other suitable material. In various embodiments, some of the individually prepackaged containers 12 may be comprised of one or more plastics, such as a thermoplastic polystyrene, for example, metals, alloys, or paper products. The individually prepackaged containers 12 may be covered, sealed, enclosed, and/or capped using any suitable methods. In one embodiment, the individually prepackaged containers 12 may be wrapped in a wrapper or sealed in a plastic, paper, metal, and/or alloy sheet or film to maintain, or at least partially maintain, the sterility of the individually prepackaged containers 12 prior to consumption.

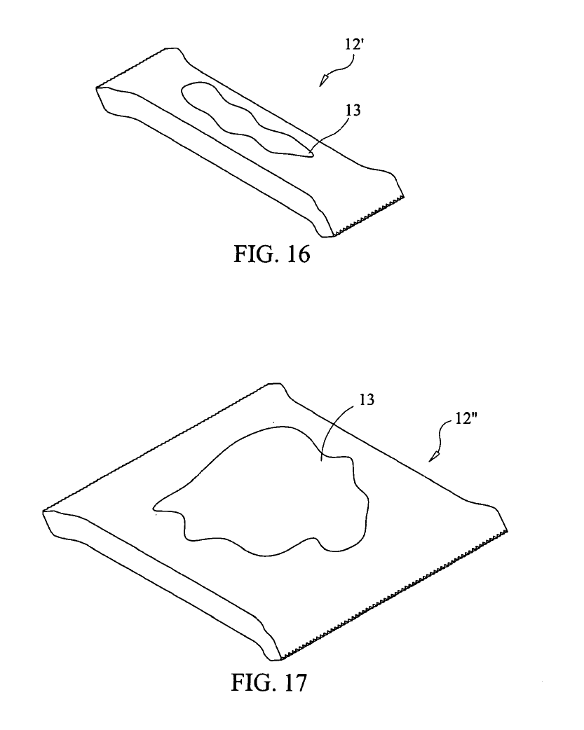

In one embodiment, referring to FIGS. 16 and 17, individually prepackaged containers 12′ and 12″ may comprise flexible wrappers, for example. These types of individually prepackaged containers 12′ and 12″ may be used to house or contain bar type food products or snacks, for example.

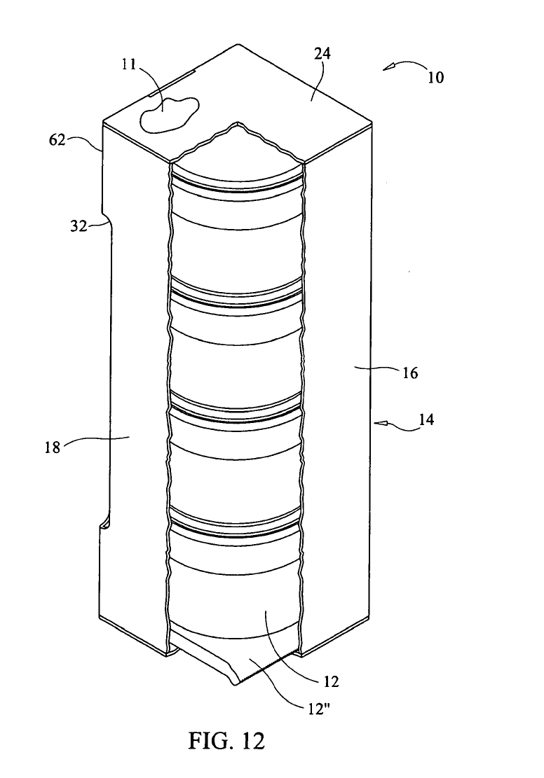

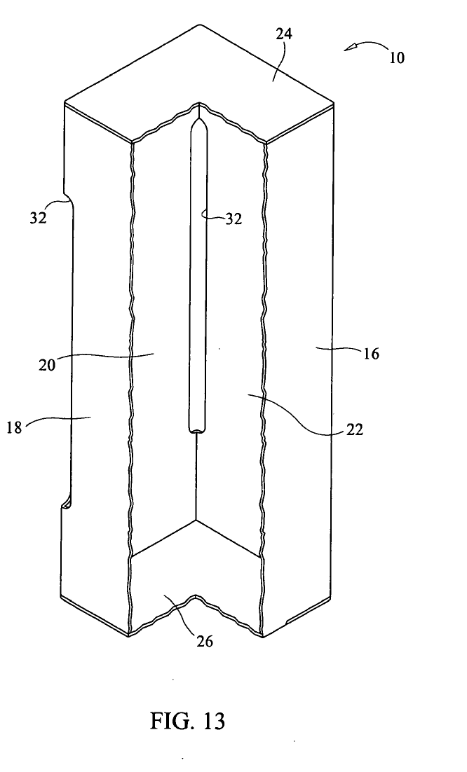

In one embodiment, referring to FIGS. 14-17, all of the individually prepackaged containers 12 may comprise the same general shape, size, and/or composition or, in other embodiments, the individual prepackaged containers 12 may comprise one or more different shapes, sizes, and/or compositions. In one embodiment, the individually prepackaged containers 12 may comprise four generally cup or bowl-shaped containers and a generally bar-shaped container 12′ or 12″ housing. The four generally cup or bowl-shaped individually prepackaged containers 12 and the bar-shaped container 12′ or 12″ may be positioned within the hollow body portion 14 of the container 10 (see e.g., FIG. 12). In other various embodiments, more than one bar-shaped container 12′ or 12″ and less than four generally cup or bowl shaped containers may be provided within the hollow body portion 14 of the container 10. In various embodiments, at least three but less than seven individually prepackaged containers 12, 12′, and/or 12″ may be provided in the hollow body portion 14 of the container 10. In one embodiment, four individually prepackaged containers 12, 12′, and/or 12″ may be provided.

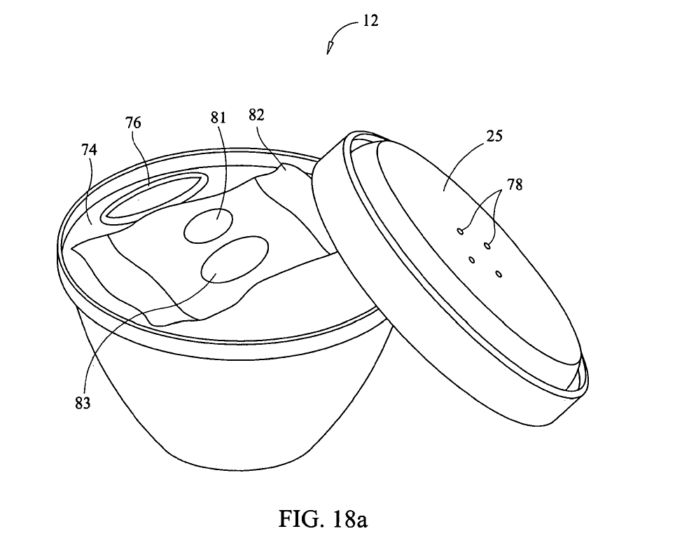

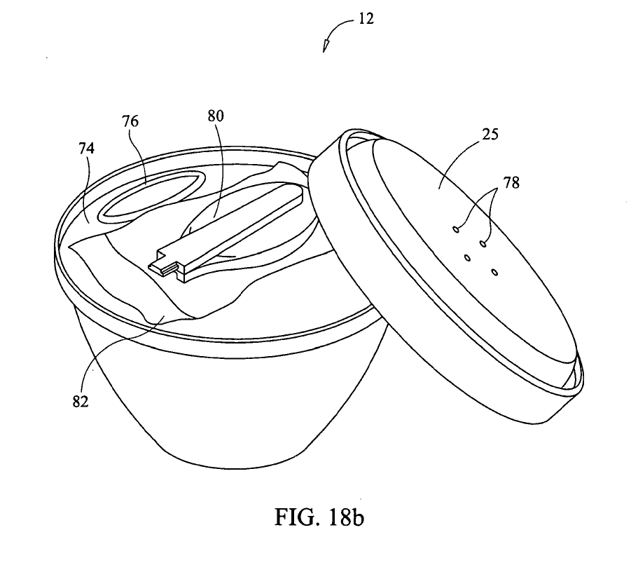

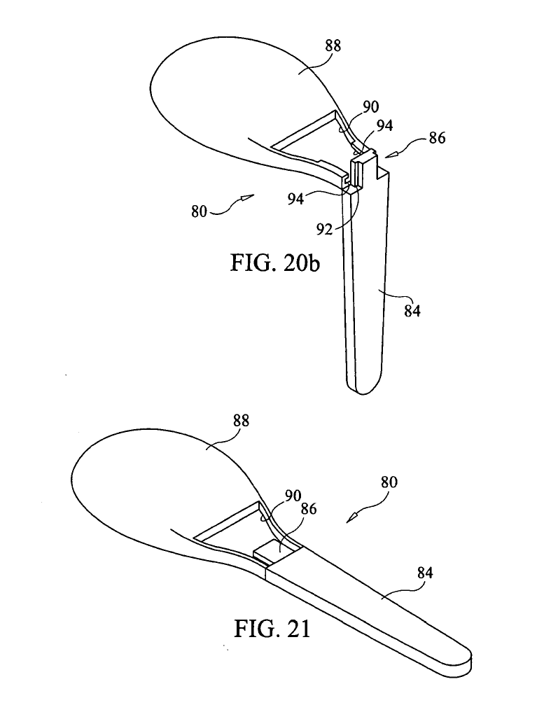

In one embodiment, referring to FIGS. 18-21, the container 10 may comprise one or more utensils or tools or a collapsible utensil 80 for consuming the edible components within the individually prepackaged containers 12. In one embodiment, a spoon, fork, knife, and/or spork (i.e., combination spoon and fork) may be packaged with the individually prepackaged containers 12 or provided within the container 10. The one or more utensils or tools also may be attached to the container 10 or attached to or positioned on the individually prepackaged containers 12. In one embodiment, the utensils or tools may be positioned within a wrapper 82 and may be positioned intermediate the peelable lid 74 and the lid 25 of the individually prepackaged containers 12. In one embodiment, absorbent products, such as napkins or wipes, for example, also may be positioned within or attached to the container 10 or attached to the individually prepackaged containers 12.

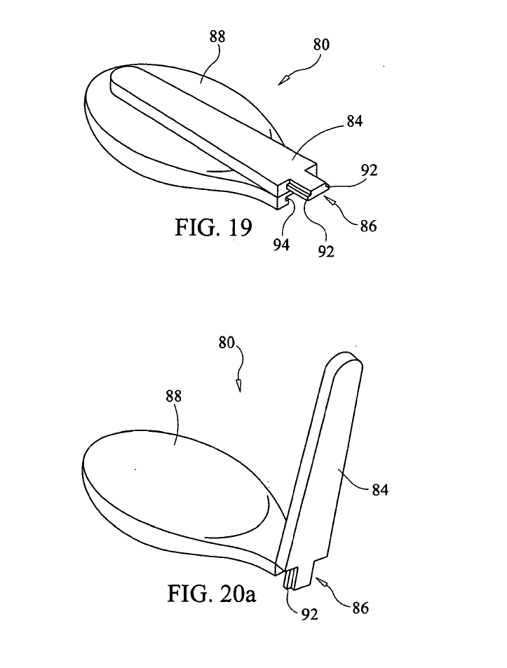

In various embodiments, referring to FIGS. 19-21, the collapsible utensil 80 may comprise a handle portion 84 comprising a projection 86 and a food-contacting portion 88. The handle portion 84 may be movably or rotatably connected to the food-contacting portion 88 such that the collapsible utensil 80 may be movable and/or rotatable between a first, collapsed position (FIG. 19) and a second, non-collapsed position (FIG. 21). In one embodiment, the food-contacting portion 88 may comprise a recess 90, wherein the projection 86 is configured to be engaged with the recess 90 when the collapsible utensil 80 is moved into the second, non-collapsed position. In various embodiments, the projection 86 may be snap-fit, press-fit, and/or otherwise engaged with the recess 90 by any suitable method. In one embodiment, the projection 86 may comprise one or more lips 92 configured to engage grooves 94 defined in side walls of the recess 90. Although the collapsible utensil 80 is illustrated as a spoon, the collapsible utensil 80 may also comprise a knife, a fork, and/or a spork. In various embodiments, more than one collapsible utensil 80 may be provided with an individually prepackaged container 12 and/or the container 10.

In one embodiment, the individually prepackaged containers 12 may be provided in any number of physical arrangements within the hollow body portion 14 of the container 10. In one embodiment, the individually prepackaged containers 12, 12′, and/or 12″ may be stackably arranged within the hollow body portion 14 of the container 10 (see e.g., FIG. 12). The arrangement of the individually prepackaged containers 12, 12′, and/or 12″ may have a general linear or non-linear arrangement and/or profile. In various embodiments, the individually prepackaged containers 12 also may be positioned in any suitable arrangement within the hollow body portion of the container 10. In one embodiment, the individually prepackaged containers 12 may be provided within the hollow body portion 14 of the container 10 in such a manner as to allow the individual to sequentially remove the individually prepackaged containers 12 in a particular order of consumption, for example, in order, breakfast, early lunch, late lunch, dinner, and evening snack. In various embodiments, the individually prepackaged containers 12 may comprise edible components therein sufficient to meet the dietary or daily dietary needs of an individual for one day. In one embodiment, each meal may comprise one or more individually prepackaged containers 12, while in other various embodiments, each meal may only comprise only one individually prepackaged container 12.

In one embodiment, a meal may comprise any amount of edible content that is generally consumed in one sitting or within a reasonable timeframe. In various embodiments, a meal may comprise a snack or a single or a multi-course meal. The terms breakfast, brunch, lunch, dinner, and snack whether modified by the terms first, second, third, fourth, fifth, early, middle, and/or late are not intended to be limiting as to traditional timing and do not necessarily dictate the order in which the meals are to be consumed, rather the terms are intended to aid the reader in understanding the embodiments in which they are used. In one embodiment, the container 10 may comprise multiple meals sufficient to meet the dietary requirements of an individual for one day or about one full day. In various embodiments, the meals may comprise an early and late breakfast, a brunch, a lunch, a first and second dinner, and an evening snack, for example. In one embodiment, the meals may comprise a breakfast, an early lunch, a late lunch, a dinner, and an evening snack, for example. In one embodiment, the container 10 may comprise three meals: a breakfast, a lunch, and a dinner. In another embodiment, the container 10 may comprise four meals: a breakfast, an early lunch, a late lunch, and a dinner. In yet another embodiment, the container 10 may comprise: a breakfast, an early lunch, a late lunch, a dinner, and a snack. In still other embodiments, the container 10 may comprise: a breakfast, an early lunch, a late lunch, a dinner, and one or more snacks. In various embodiments, the consumption schedule for the various meals may comprise uniform or non-uniform time intervals. Those of skill in the art will recognize that other suitable meal combinations also may be packaged within the container 10 for a particular caloric or nutrient component intake requirements of an individual, either on a per meal basis or on a daily basis.

In one embodiment, the order in which the various meals are consumed may follow a traditional and/or an accepted order (e.g., breakfast, early lunch, late lunch, dinner, and snack). In various embodiments, the various meals may be consumed at standard time intervals throughout the day. In one embodiment, the meals may be consumed about two hours apart, about three hours apart, or about four hours apart, for example. In certain embodiments, the meals may be consumed about three hours apart, plus or minus one hour. In various embodiments, the various meals may also be consumed at non-standard time intervals. In one embodiment, the first meal may be consumed within about fifteen minutes to about 2 hours after awakening and the second meal may be consumed within about four hours of awakening and/or within about three hours after consuming the first meal. In one embodiment, the time interval between the consumption of the second and third meals may be less than the time interval between the third and the fourth meals and less than the time interval between the first and second meals. In various embodiments, the third meal may be consumed within about two hours, about three hours, or about four hours after consumption of the second meal, but about three hours or about four hours before consumption of the fourth meal. In one embodiment, the fifth meal may be consumed about one hour or about two hours prior to going to bed for the day. In other embodiments, the fifth meal or a sixth meal may be consumed about one hour before or after a specific activity (e.g., exercise). In one embodiment, the timing of consumption of the various meals may not be set to a particular schedule and the meals may be consumed when a user of the container 10 is hungry or has time to consume a meal.

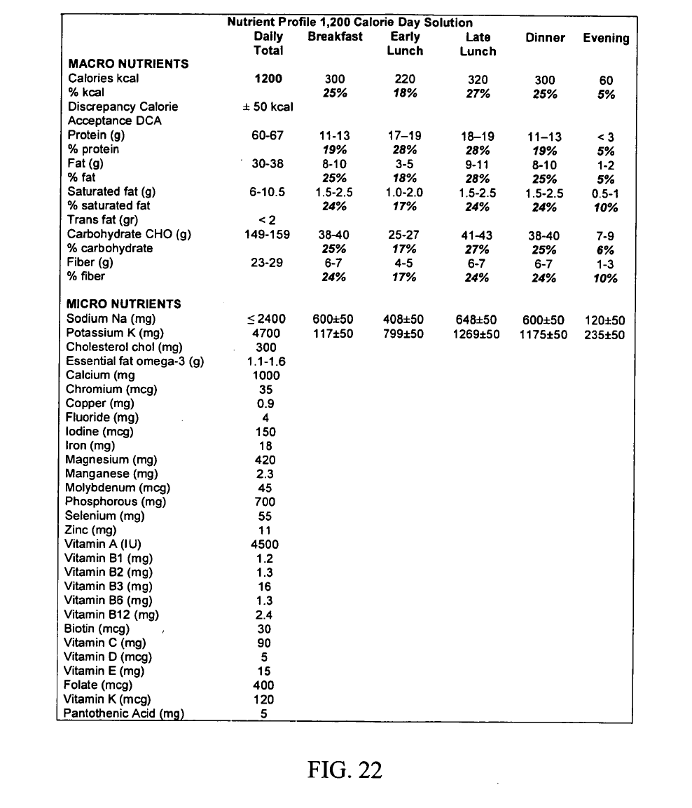

Those of ordinary skill in the art will recognize that a single predetermined daily Calorie level may not meet the full nutritional needs of each individual. Thus, in various embodiments, particular containers 10 may provide different daily predetermined Calorie levels. In one embodiment, the sum of the Calories contained in various containers 10 may be standardized to a particular range or number of Calories. FIGS. 22, 23, 37, 38, 52, 53, and 68 provide non-limiting examples of nutrient profiles for 1,200, 1,600, 2,000, and 2,400 Calorie level meal plans.

In one embodiment, all containers 10 within a particular Calorie level may consistently provide about the same nutritional components and caloric content, irrespective of the meal combinations (i.e., different breakfasts, different lunches, different dinners, and/or different snacks). In certain embodiments, the container 10 may comprise about 1,200 Calories. In such an embodiment, there may be multiple containers 10, each having differing combinations of meals for variety; however, each of the containers 10 may comprise about 1,200 Calories such that each is about nutritionally equal. In other embodiments, the containers 10 may comprise Calorie levels of about 1,200 Calories, about 1,600 Calories, about 2,000 Calories, and/or about 2,400 Calories, examples of which according to various embodiments are provided in FIGS. 22, 23, 37, 38, 52, 53, and 68. In certain embodiments, the containers 10 may also comprise other suitable Calorie ranges. As a result, containers 10 comprising Calorie levels of about 900 Calories, about 1,000 Calories, about 1,400 Calories, about 1,800 Calories, about 2,200 Calories, about 2,600 Calories, about 2,800 Calories, about 3,000 Calories, and/or about 3,200 Calories, for example, are within the scope of the present disclosure. In various embodiments, the containers 10 may each comprise a consistent, or substantially consistent, allotment of Calories per meal (e.g., breakfast, lunch, dinner, and/or snack) as a percentage of total Calories within and among Calorie levels.

In one embodiment, the containers 10 may comprise predetermined daily Calorie levels of about 1,150 Calories to about 1,250 Calories, about 1,525 Calories to about 1,675 Calories, about 1,900 Calories to about 2,100 Calories, and/or about 2,275 Calories to about 2,525 Calories.

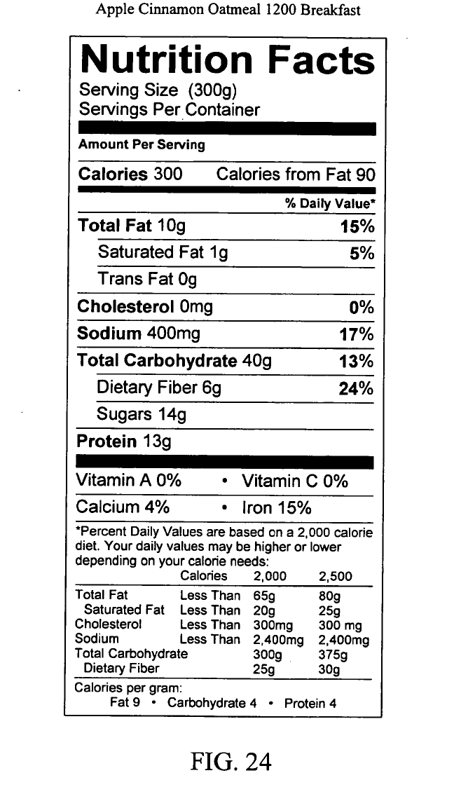

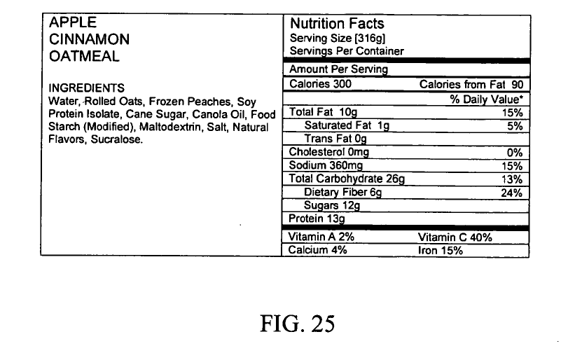

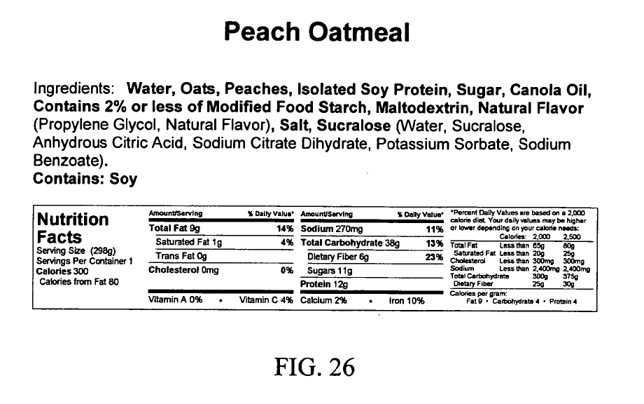

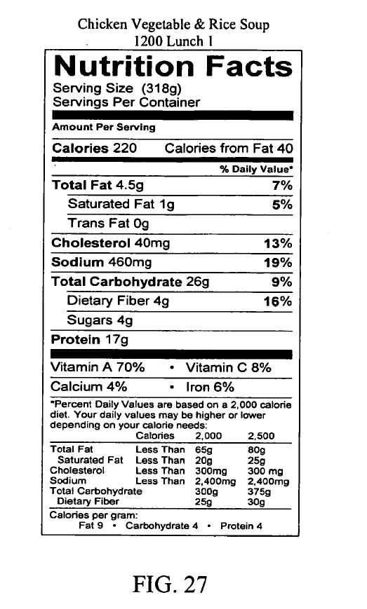

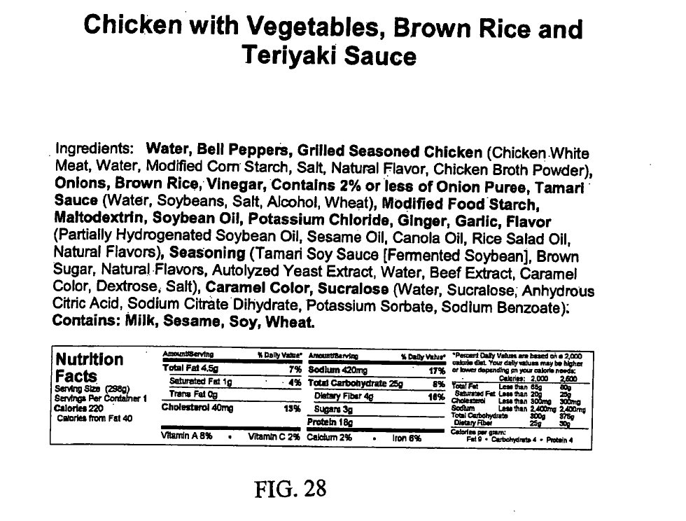

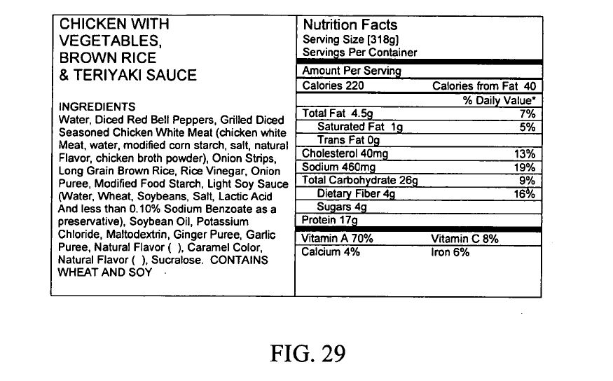

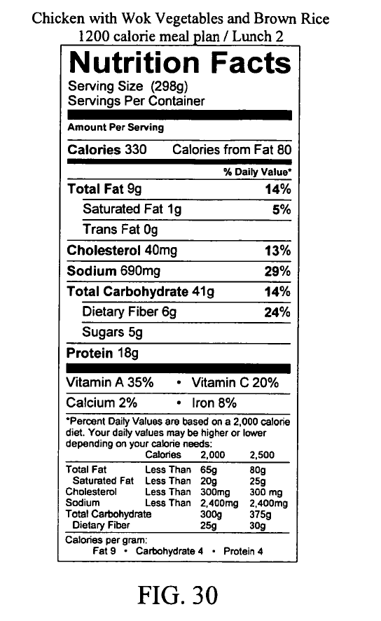

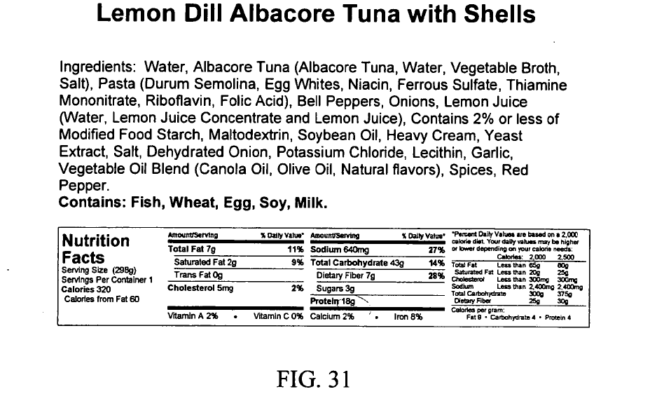

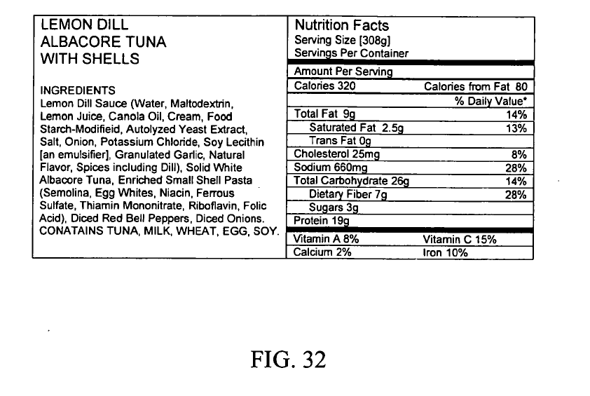

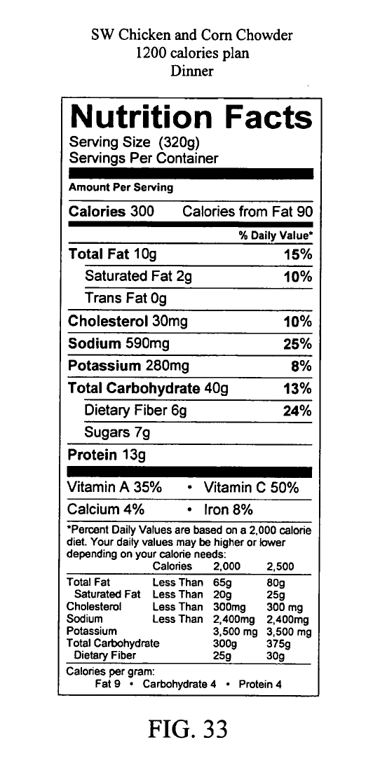

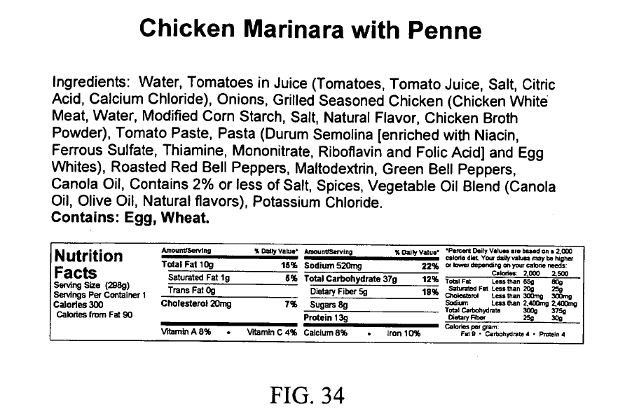

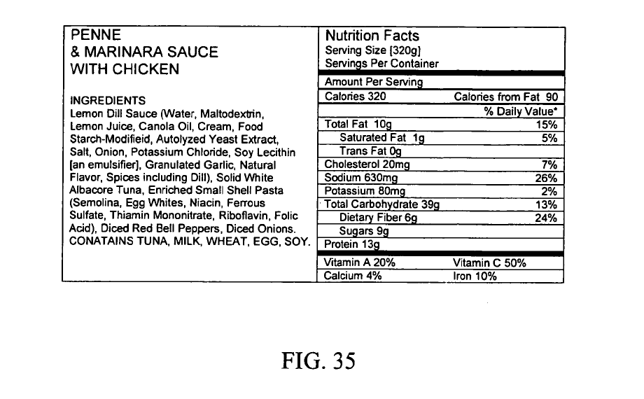

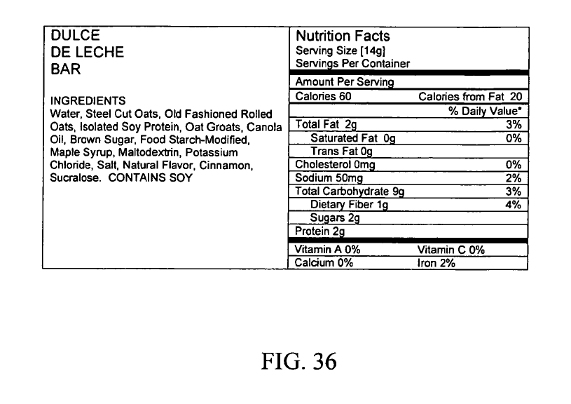

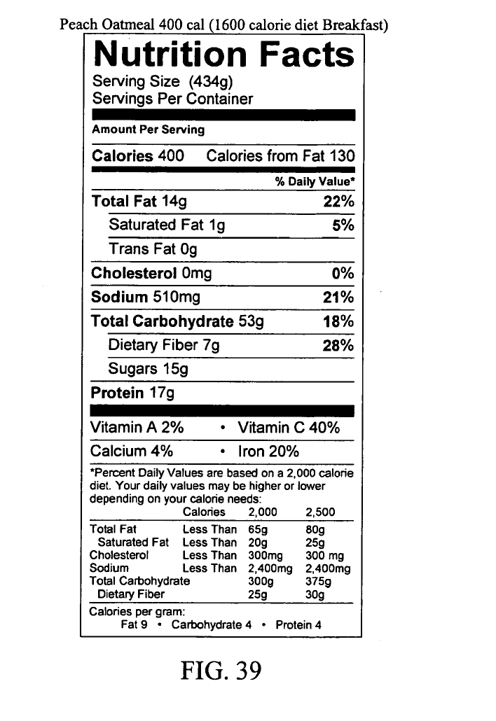

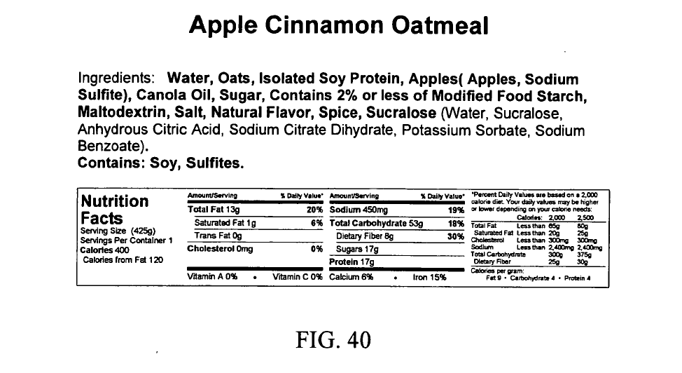

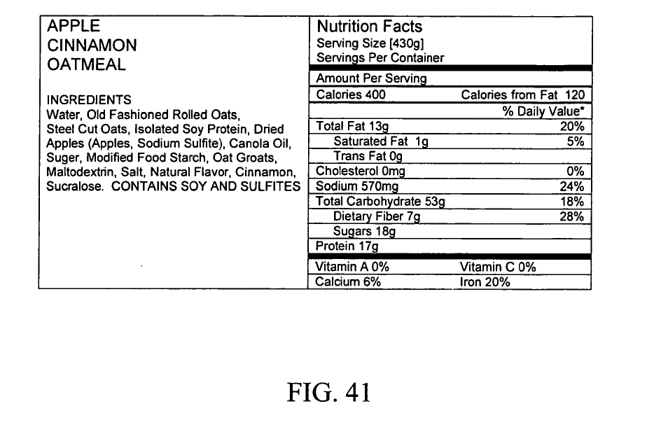

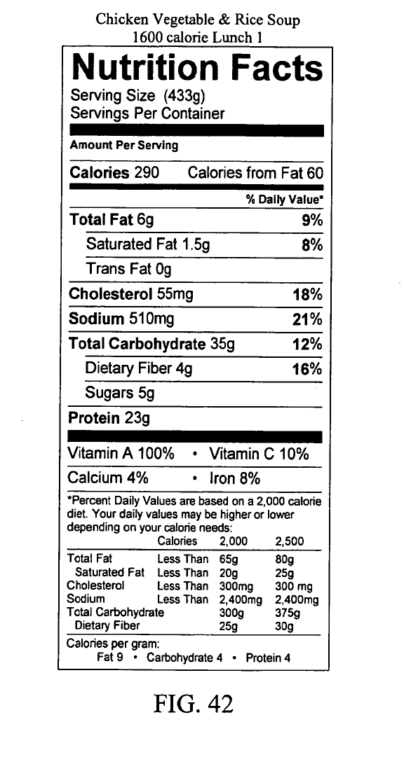

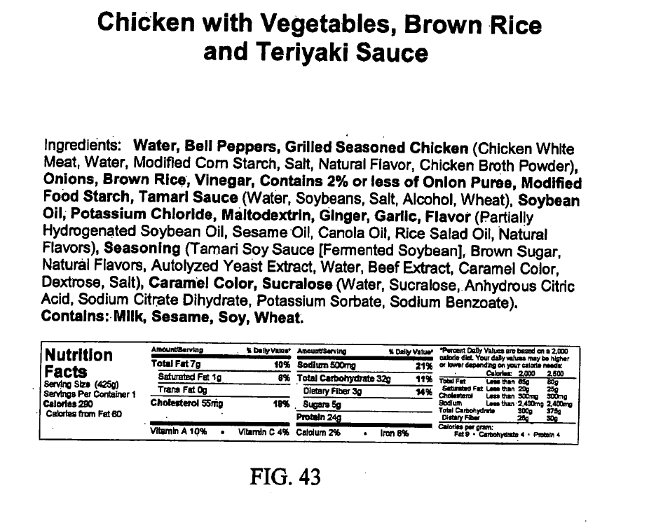

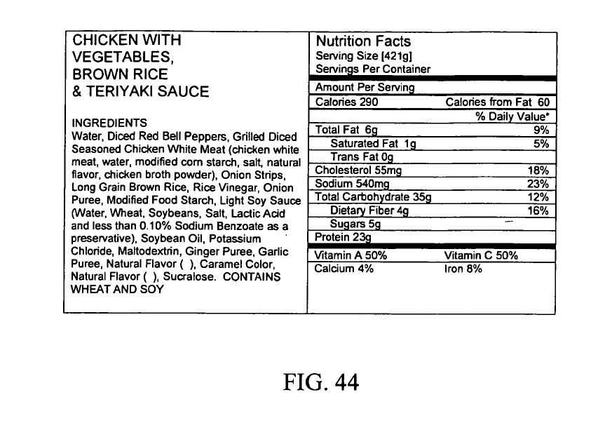

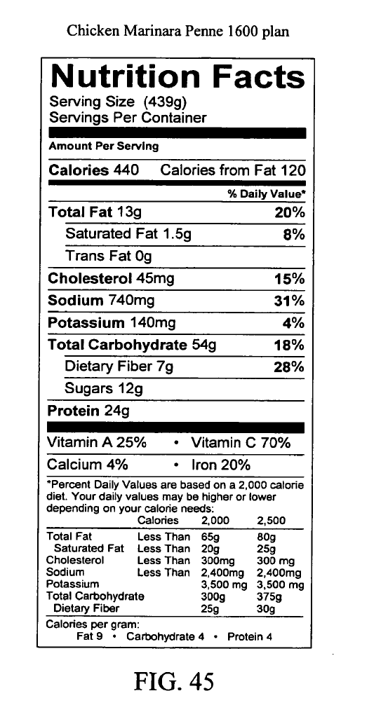

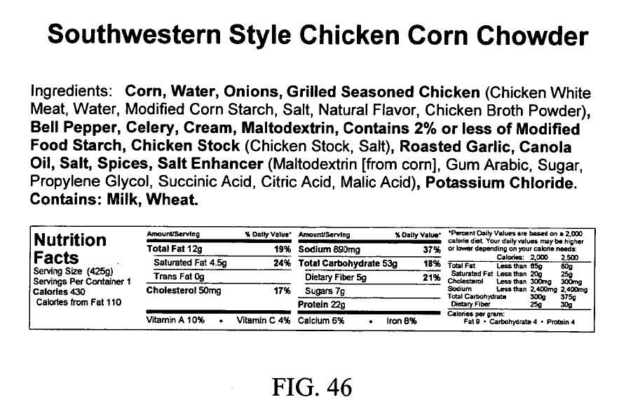

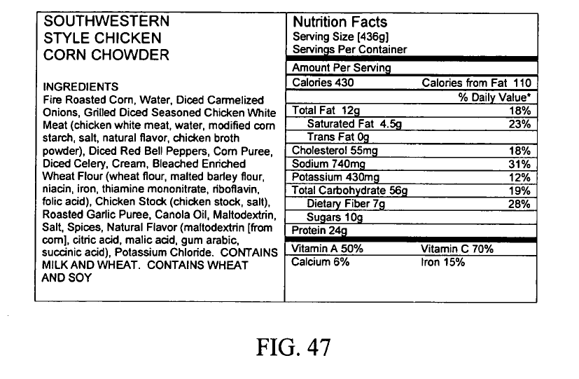

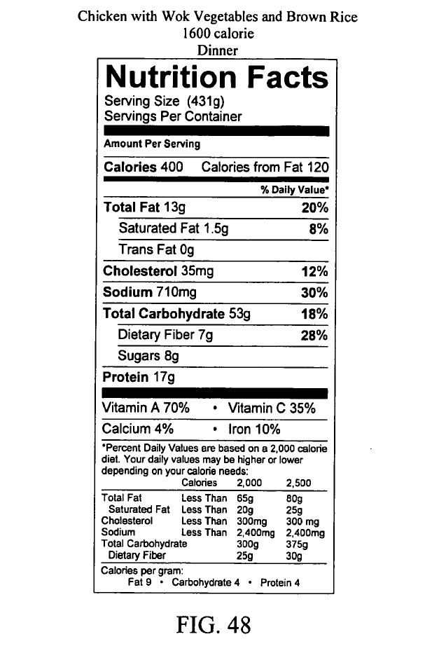

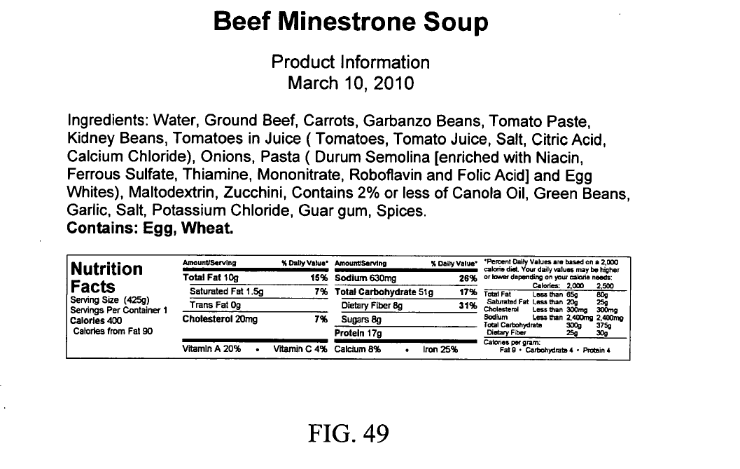

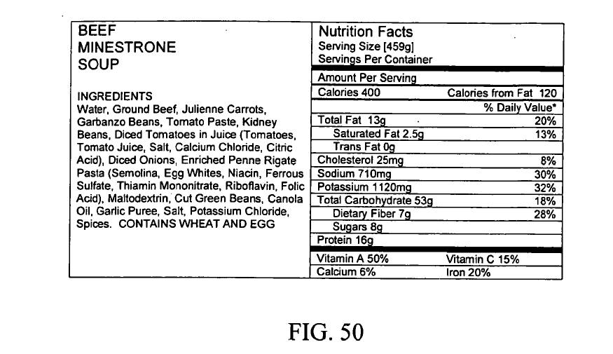

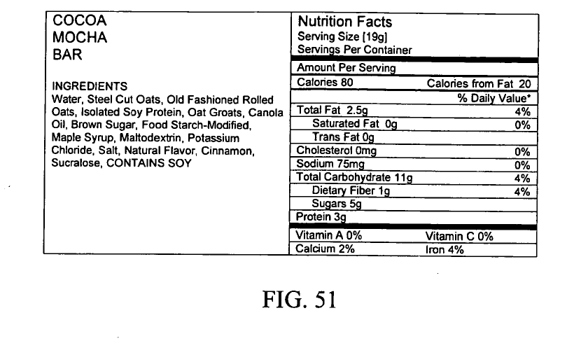

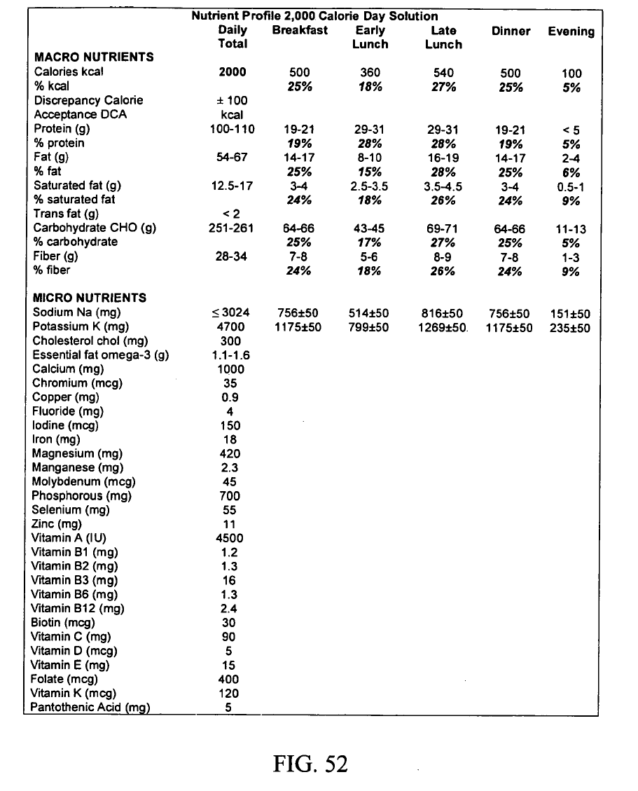

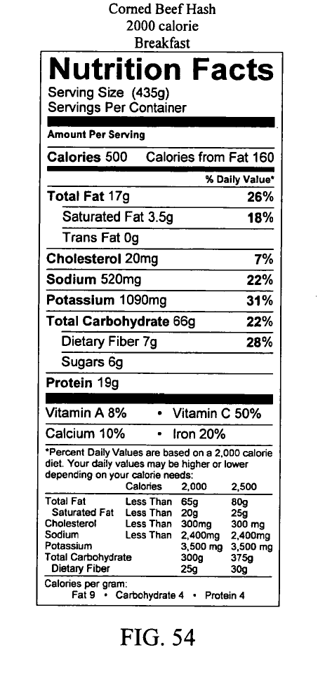

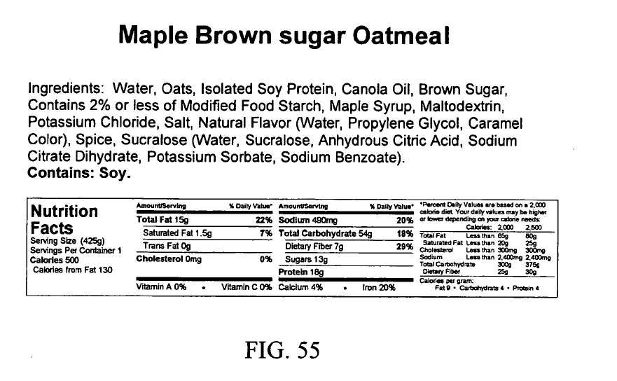

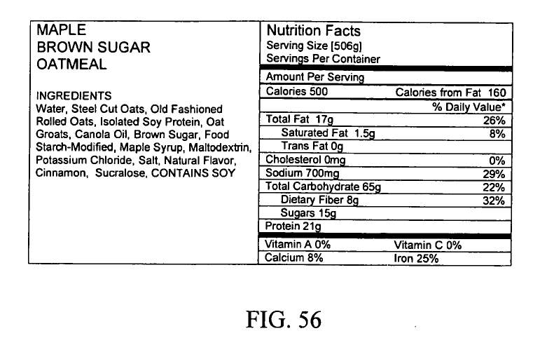

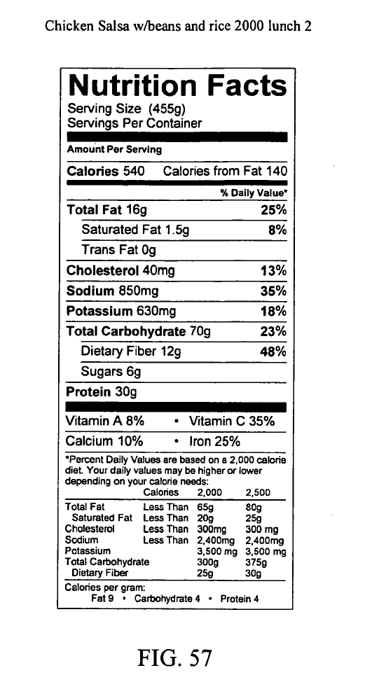

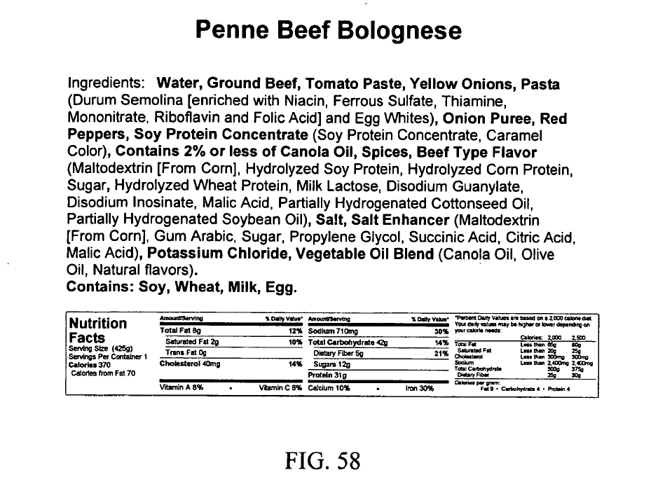

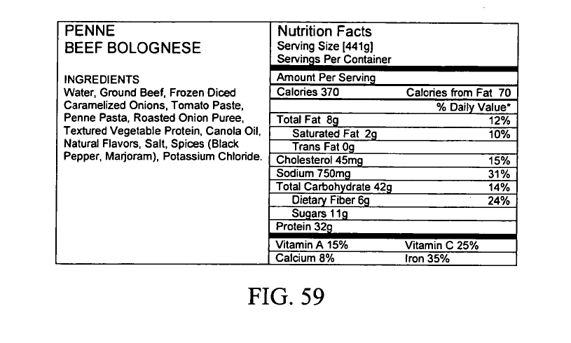

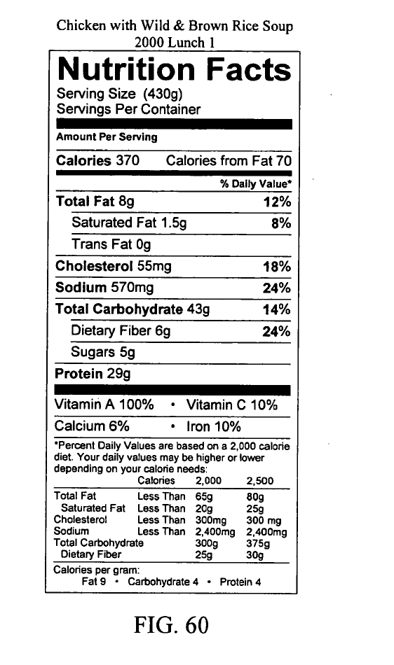

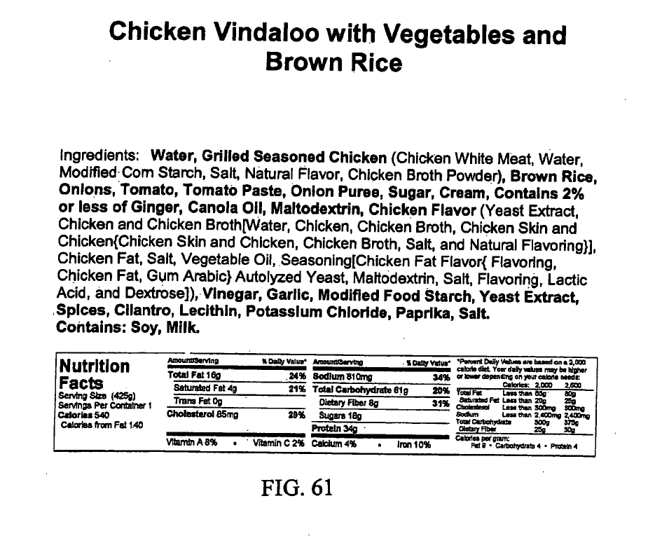

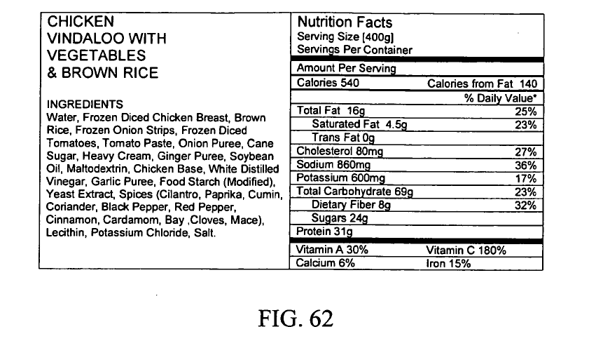

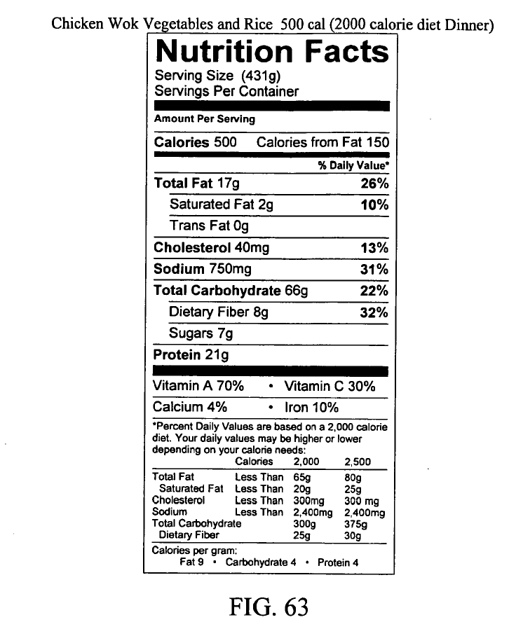

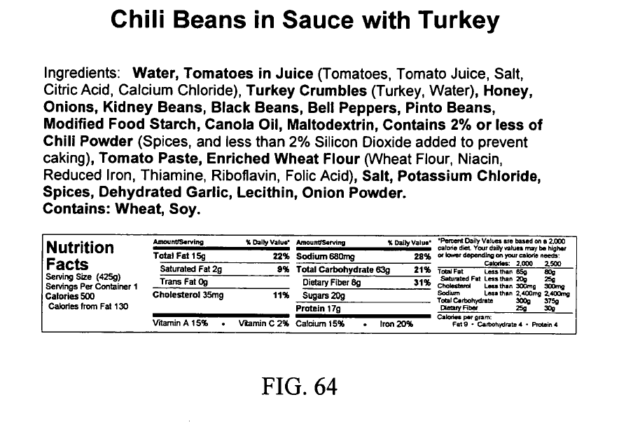

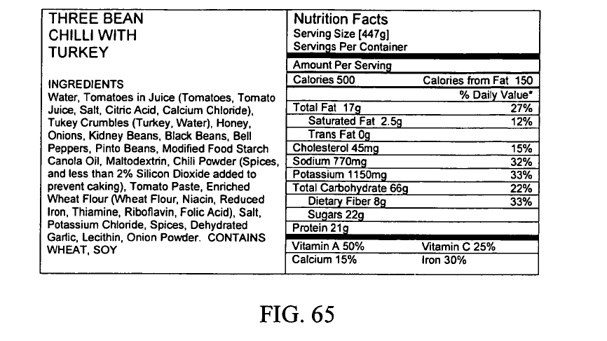

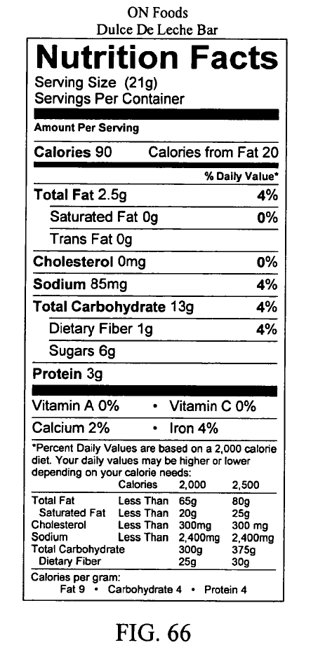

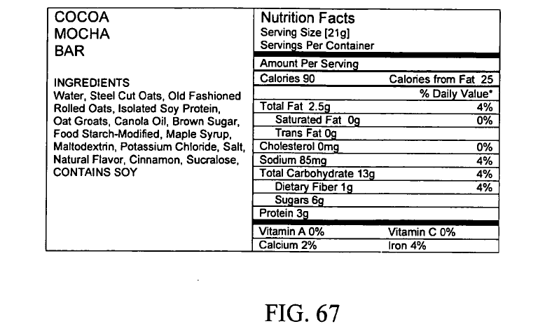

In various embodiments, the container 10 may comprise multiple meals having one or more different edible components. In certain embodiments, the containers 10 within a particular Calorie level (e.g., 1,200 Calories, 1,600 Calories) may contain differing combinations of meals. In one embodiment, all of the containers 10 within the same Calorie level may provide the same or about the same amount of Calories. In such an embodiment, a week supply of containers 10 may be provided, in which each container 10 provides about 1600 Calories, for example. In certain embodiments, the Calories provided in particular meals of the containers 10 may generally have the same or a similar Caloric content. In various embodiments, referring to FIGS. 24-26, a breakfast from a 1,200 Calorie level container 10 may have about the same number of Calories as a breakfast from a different 1,200 Calorie level container 10. The same can be true for other meals in a 1,200 Calorie level container, such as an early lunch (see e.g., FIGS. 27-29), a late lunch (see e.g., FIGS. 30-32), a dinner (see e.g., FIGS. 33-35), and/or a snack (see e.g., FIG. 36), for example. In certain embodiments, referring to FIGS. 39-41, a breakfast from a 1,600 Calorie level container 10 may have about the same number of Calories as a breakfast from a different 1,600 Calorie level container 10. The same can be true for other meals in a 1,600 Calorie level container, such as an early lunch (see e.g., FIGS. 42-44), a late lunch (see e.g., FIGS. 45-47), a dinner (see e.g., FIGS. 48-50), and/or a snack (see e.g., FIG. 51), for example. In various embodiments, referring to FIGS. 52-56, a breakfast from a 2,000 Calorie level container 10 may have about the same number of Calories as a breakfast from a different 2,000 Calorie level container 10. The same can be true for other meals in a 2,000 Calorie level container, such as an early lunch (see e.g., FIGS. 57-59), a late lunch (see e.g., FIGS. 60-62), a dinner (see e.g., FIGS. 63-65), and/or a snack (see e.g., FIGS. 66 and 67), for example.

In one embodiment, the caloric contents of each of the edible components in the various individually prepackaged containers 12 may not be the same, about the same, or substantially the same. In various embodiments, the first edible component in the first individually prepackaged container may comprise about 25% of the predetermined daily caloric content, the second edible component in the second individually prepackaged container may comprise about 18% of the predetermined daily caloric content, the third edible component in the third individually prepackaged container may comprise about 27% of the predetermined daily caloric content, the fourth edible component may comprise in the fourth individually prepackaged container about 25% of the predetermined daily caloric content, and the fifth edible component in the fifth individually prepackaged container may comprise about 5% of the predetermined daily caloric content. In other various embodiments, the first edible component may comprise about 20% to about 30% of the predetermined daily caloric content, the second edible component may comprise about 13% to about 23% of the predetermined daily caloric content, the third edible component may comprise about 22% to about 32% of the predetermined daily caloric content, the fourth edible component may comprise about 20% to about 30% of the predetermined daily caloric content, and the fifth edible component may comprise about 2% to about 8% of the predetermined daily caloric content. In one embodiment, the first edible component may comprise breakfast, the second edible component may comprise an early lunch, the third edible component may comprise a late lunch, the fourth edible component may comprise a dinner, and the fifth edible component may comprise a snack or an evening snack. In various embodiments, the edible components may be consumed in the order of breakfast, early lunch, late lunch, dinner, and evening snack. In other various embodiments, the edible components can be consumed in any other suitable order.

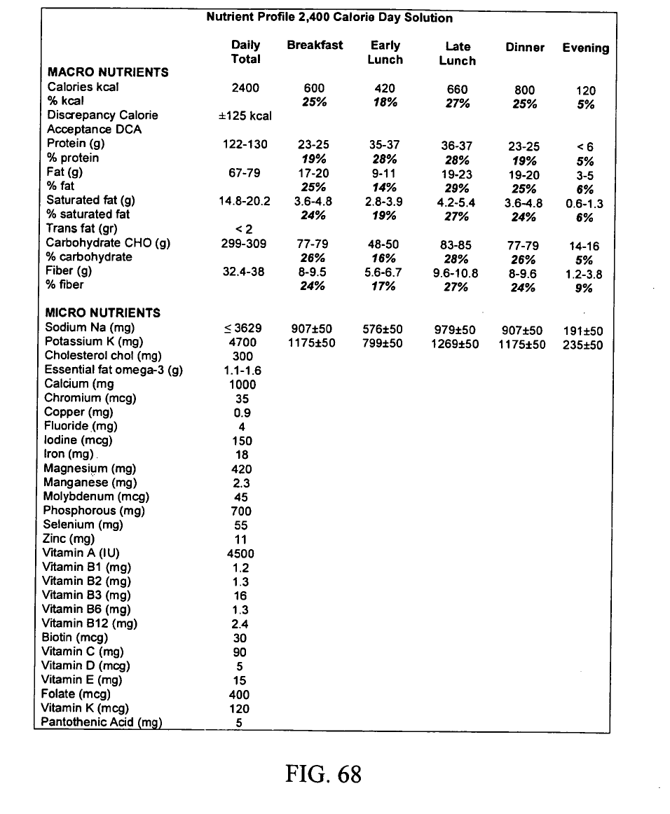

In one embodiment, the caloric contents of the edible components in the various individually prepackaged containers may comprise certain relational aspects. In various embodiments, the sum of the caloric contents of the first and the fourth edible components of the first and fourth individually prepackaged containers may be equal to or about equal to the sum of the caloric contents of the second, third, and fifth edible components of the second, third, and fifth individually prepackaged containers. “About equal to” as used herein may mean within +/−1%, +/−5%, or +/−10%, for example. In one embodiment, referring to FIG. 22, the sum of the Calories in breakfast and dinner is 600, or about 600, while the sum of the calories of early lunch, late lunch, and evening snack is 600, or about 600. In certain embodiments, the sum of the caloric contents of the second and fourth edible components of the second and fourth individually prepackaged containers may be less that the sum of the caloric contents of the first and third edible components of the first and the third individually prepackaged containers. In one embodiment, referring to FIG. 52, the sum of brunch and dinner is 860, or about 860, while the sum of breakfast and lunch is 1,040, or about 1,040. In certain embodiments, the sum of the caloric contents of the first and second edible components of the first and second individually prepackaged containers may be between about 36% and about 49% of the predetermined daily caloric content of the container 10, for example. In one embodiment, referring to FIG. 68, the predetermined daily caloric content of the container is 2,400, or about 2,400, and the sum of the caloric contents of breakfast and brunch is 1,020, or about 1,020, thus, about 43%.

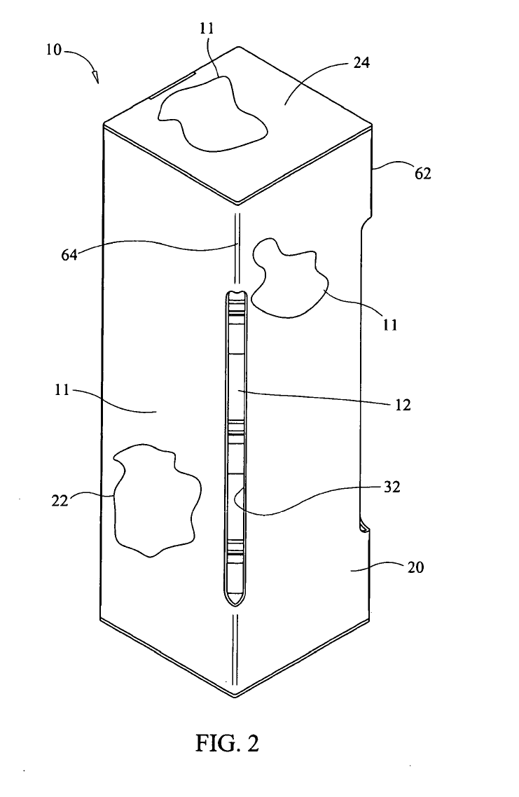

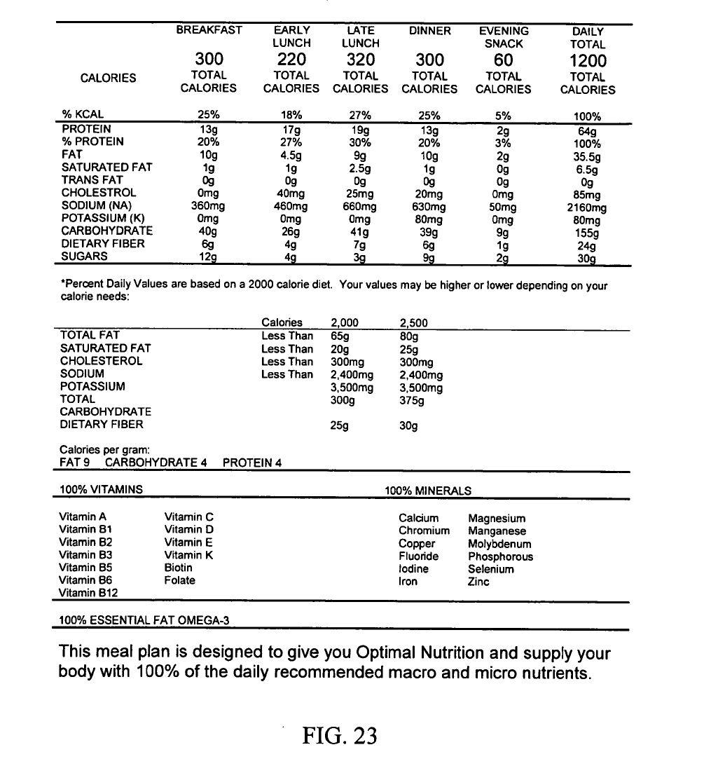

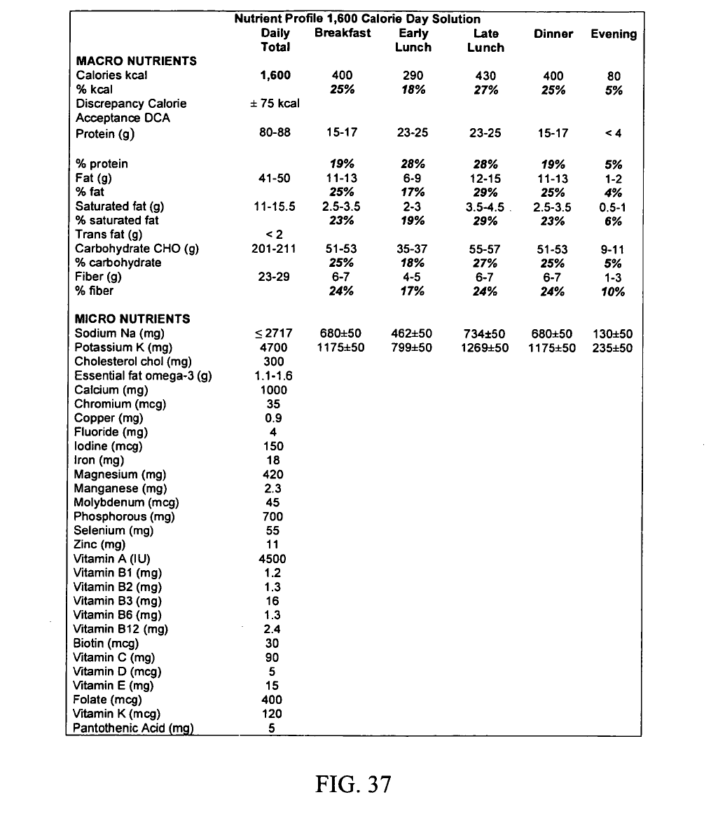

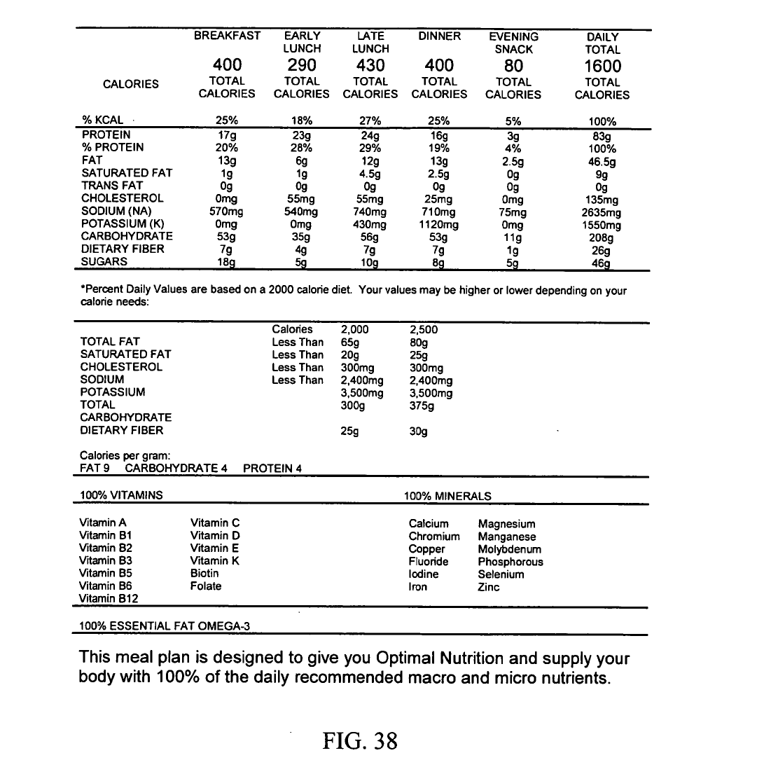

In various embodiments, the container 10 may provide consistent allocation of one or more macro nutrients as a percentage of total Calories within the container 10. In one embodiment, macro nutrients may comprise protein, fat, including saturated fat, carbohydrates, and/or dietary fiber. In various embodiments, the proportion of the predetermined daily caloric content comprising fat may be the same as or about the same at all container 10 Calorie levels (see e.g., 1,200 Calories example at FIGS. 22 and 23; 1,600 Calories example at FIGS. 37 and 38; 2,000 Calories example at FIGS. 52 and 53, and 2,400 Calories example at FIG. 68). In one embodiment, the predetermined daily caloric content divided by the sum of fat grams in the edible components may be between about 29 and about 41. In one embodiment, referring to FIG. 23, the predetermined caloric content 1,200, or about 1,200, divided by the sum of fat grams in the edible components 35.5, or about 35.5, is about 33.8, for example.

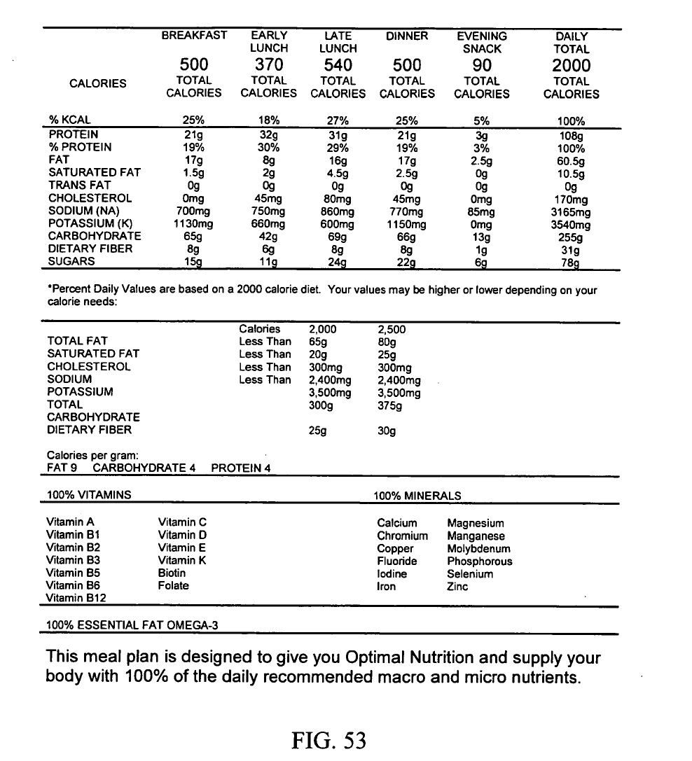

In certain embodiments, the proportion of the predetermined daily caloric content comprising carbohydrates may be the same as or about the same at all container 10 Calorie levels (see e.g., 1,200 Calories example at FIGS. 22 and 23; 1,600 Calories example at FIGS. 37 and 38; 2,000 Calories example at FIGS. 52 and 53, and 2,400 Calories example at FIG. 68). In certain embodiments, the predetermined daily caloric content divided by the sum of carbohydrate grams in the edible components may be between about 7.4 and about 8.2. In one embodiment, referring to FIG. 53, the predetermined daily caloric content 2,000, or about 2,000, divided by the sum of carbohydrate grams in the edible components 255, or about 255, is about 7.8, for example.

In various embodiments, the container 10 may comprise a consistent or substantially consistent allocation of one or more macro nutrients comprising protein, fat, carbohydrate and/or dietary fiber as a percentage of the daily allotment of the macro nutrient among the provided edible components of the individually prepackaged containers 12 within each Calorie level (see e.g., FIGS. 22, 37, 52). In one embodiment, the container 10 may comprise a consistent or substantially consistent allocation of one or more macro nutrients comprising protein, fat, carbohydrate and/or dietary fiber as a percentage of the daily allotment of the macro nutrient among the provided edible components of the individually prepackaged containers 12 between two Calorie levels or among three or more Calorie levels.

In one embodiment, the amount of protein provided in each of the edible components of the various individually prepackaged containers 12 may be represented as a percentage of the predetermined daily nutritional content of protein (see e.g., FIGS. 22, 23, 37, 38, 52, 53, and 68). In such an embodiment, the nutritional content of protein contained in the first edible component may be about 15% to about 25%, or about 20%, of the predetermined daily nutritional content of protein, the nutritional content of protein in the second edible component may be about 26% to about 34%, or about 30%, of the predetermined daily nutritional content of protein, the nutritional content of protein in the third edible component may be about 26% to about 34%, or about 30%, of the predetermined daily nutritional content of protein, the nutritional content of protein in the fourth edible component may be about 15% to about 25%, or about 20%, of the predetermined daily nutritional content of protein, and the nutritional content of protein in the fifth edible component may be about 2% to about 8%, or about 5%, of the predetermined daily nutritional content of protein. In certain embodiments, the sum of the nutritional content of protein in the first, fourth, and fifth edible components in the first, fourth, and fifth individually prepackaged containers may be less than the sum of the nutrient content of protein in the second and third edible components of the second and third individually prepackaged containers, for example. In one embodiment, referring to FIG. 37, breakfast comprises about 15-17 g of protein, dinner comprises about 15-17 g of protein, and an evening snack comprises less than about 4 g of protein while brunch comprises about 23-25 g of protein and lunch comprises about 23-25 g of protein, thus, about 30 to about 39 is less than about 46 to about 50, for example. In one embodiment, the daily amount of protein provided within each container 10 may comprise protein sources comprising about 50% beef, poultry and/or fish/seafood proteins, about 25% soy protein, and/or about 25% whey and/or other milk proteins. In certain embodiments, hydrolyzed animal proteins may not be used.

In one embodiment, the amount of fat provided in each of edible components of the various individually prepackaged containers 12 may be represented as a percentage of the predetermined daily nutritional content of fat. In such an embodiment, the nutritional content of fat contained in the first edible component may be about 20% to about 30%, or about 25%, of the predetermined daily nutritional content of fat, the nutritional content of fat in the second edible component may be about 10% to about 22%, or about 16%, of the predetermined daily nutritional content of fat, the nutritional content of fat in the third edible component may be about 22% to about 34%, or about 28%, of the predetermined daily nutritional content of fat, the nutritional content of fat in the fourth edible component may be about 20% to about 30%, or about 25%, of the predetermined daily nutritional content of fat, and the nutritional content of fat in the fifth edible component may be about 2% to about 8%, or about 5%, of the predetermined daily nutritional content of fat. In one embodiment, fat sources may comprise olive oil, canola oil, and/or soybean oil in addition to nuts and omega-3 sources.

In one embodiment, the amount of saturated fat provided in each of the edible components of the various individually prepackaged containers 12 may be represented as a percentage of the predetermined daily nutritional content of saturated fat. In such an embodiment, the nutritional content of saturated fat contained in the first edible component may be about 19% to about 29%, or about 24%, of the predetermined daily nutritional content of saturated fat, the nutritional content of saturated fat in the second edible component may be about 14% to about 24%, or about 19%, of the predetermined daily nutritional content of saturated fat, the nutritional content of saturated fat in the third edible component may be about 22% to about 34%, or about 27%, of the predetermined daily nutritional content of saturated fat, the nutritional content of saturated fat in the fourth edible component may be about 19% to about 29%, or about 24%, of the predetermined daily nutritional content of saturated fat, and the nutritional content of saturated fat in the fifth edible component may be about 3% to about 13%, or about 8%, of the predetermined daily nutritional content of saturated fat.

In one embodiment, the amount of carbohydrates provided in each of edible components of the various individually prepackaged containers 12 may be represented as a percentage of the predetermined daily nutritional content of carbohydrates. In such an embodiment, the nutritional content of carbohydrates contained in the first edible component may be about 20% to about 30%, or about 25%, of the predetermined daily nutritional content of carbohydrates, the nutritional content of carbohydrates in the second edible component may be about 12% to about 23%, or about 17%, of the predetermined daily nutritional content of carbohydrates, the nutritional content of carbohydrates in the third edible component may be about 22% to about 34%, or about 27%, of the predetermined daily nutritional content of carbohydrates, the nutritional content of carbohydrates in the fourth edible component may be about 20% to about 30%, or about 25%, of the predetermined daily nutritional content of carbohydrates, and the nutritional content of carbohydrates in the fifth edible component may be about 2% to about 8%, or about 5%, of the predetermined daily nutritional content of carbohydrates. In various embodiments, SPLENDA®, honey, and/or other suitable sweetener may be used as an artificial sweetener. In one embodiment, carbohydrates may comprise a variety of whole grains, brown rice, quinoa, millet, amaranth, and/or whole wheat, for example. In one embodiment, refined grains may not be used.

In one embodiment, the amount of dietary fiber provided in each of edible components of the various individually prepackaged containers 12 may be represented as a percentage of the predetermined daily nutritional content of dietary fiber. In such an embodiment, the nutritional content of dietary fiber contained in the first edible component may be about 14% to about 34%, or about 24%, of the predetermined daily nutritional content of dietary fiber, the nutritional content of dietary fiber in the second edible component may be about 7% to about 27%, or about 17%, of the predetermined daily nutritional content of dietary fiber, the nutritional content of dietary fiber in the third edible component may be about 15% to about 35%, or about 25%, of the predetermined daily nutritional content of dietary fiber, the nutritional content of dietary fiber in the fourth edible component may be about 14% to about 34%, or about 24%, of the predetermined daily nutritional content of dietary fiber, and the nutritional content of dietary fiber in the fifth edible component may be about 2% to about 25%, or about 10%, of the predetermined daily nutritional content of dietary fiber. In one embodiment, fibers may be provided in about a three to one insoluble to soluble ratio.

In one embodiment, the edible components in the various individually prepackaged containers 12 may comprise micro nutrients comprising potassium, cholesterol, essential fat omega-3, calcium, chromium, copper, fluoride, iodine, iron, magnesium, manganese, molybdenum, phosphorous, selenium, zinc, vitamin A, vitamin B1, vitamin B1, vitamin B3, vitamin B6, vitamin B12, biotin, vitamin C, vitamin D, vitamin E, folate, vitamin K, and/or pantothenic acid, for example. In such an embodiment, the amount of micro nutrients provided within the container 10 may be the same, about the same, substantially the same, or different at all Calorie levels. In certain embodiments, the above listed micro nutrients may provide about 90% to about 160% of the daily recommended requirement of each micro nutrient. In other embodiments, the above listed micro nutrients may provide between about 100%, but less than 150%, of the daily recommended requirement of each micro nutrient. In still other embodiments, the above listed micro nutrients may provide about 100% of the daily recommended requirement of each micro nutrient.

In one embodiment, the edible components of the various individually prepackaged containers may comprise the micro nutrient sodium. In one such embodiment, the amount of sodium provided in the containers 10 may be the same or substantially the same at all values of the daily caloric level (e.g., 1,200, 1,600, 2,000, or 2,400 daily Calories). In various embodiments, the amount of sodium may differ among the containers 10 within the same or different Calorie levels. In one embodiment, the amount of sodium may be about the same among the containers 10 of the same Calorie level, while the amount of sodium may differ proportionally among the containers 10 of different Calorie levels.

In one embodiment, the edible components of the various individually prepackaged containers 12, 12′, and/or 12″ may comprise the micro nutrients potassium and sodium at about a two to one ratio.

In various embodiments, the micro nutrients provided in the various containers 10 may increase proportionally relative to the Calorie level (e.g., 1200 Calories, 1600 Calories, etc.).

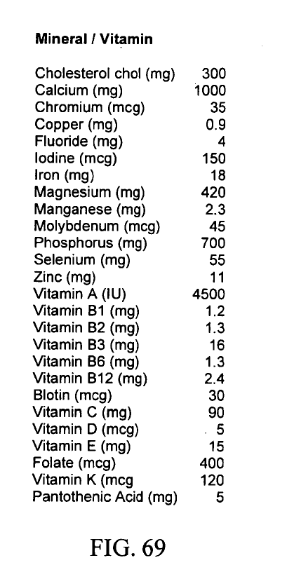

In various embodiments, the container 10 may comprise a pill pack comprising one or more pills, tablets, and/or nutrient components. The pills, tablets, and/or nutrient components may be orally ingestible, for example. In one embodiment, the pills, tablets, and/or nutrient components of the pill pack are included in the meaning of the first edible component. The nutrient component(s) provided in the pills may be micro nutrients and/or macro nutrients. In one embodiment, the pill pack 82 may comprise a pill 81 comprising vitamins and/or minerals that may supplement one or more vitamins and/or minerals otherwise supplied in the various edible components. In various embodiments, the pill pack 82 may comprise one or more pills comprising the vitamins and minerals listed in FIG. 69, for example. In other embodiments, the pill pack 82 may comprise one or more pills comprising the vitamins and minerals listed in FIG. 69 at or about the same concentrations as listed in FIG. 69. In various embodiments, the various pills within the pill pack 82 may comprise a macro nutrient component that may supplement one or more of the nutrient components comprising one or more of the proteins, fats, carbohydrates, and/or fibers within the various edible components. In one embodiment, the pill pack 82 may comprise a second pill 83 comprising a fat nutrient component, such as an omega-3 fatty acid, for example. The pill 83 may comprise about one gram to about 3 grams, or about 1.6 grams of the fat nutrient component. In one embodiment, the pill pack 82 may comprise two or more pills comprising vitamins and/or minerals and two or more pills 83 comprising the fat nutrient component. In various embodiments, the pill pack 82 may be provided with any of the meals, such as breakfast, lunch, and/or dinner, for example. In one embodiment, referring to FIG. 18a, the pill pack 82 may be provided intermediate the lid 25 and the peelable lid 74 on an individually prepackaged container 12, for example. In other various embodiments, the pill pack 82 may also be positioned within and/or attached to the container 10 and not attached to or positioned on the various individually prepackaged containers 12, 12′, or 12″. The pill packs of the present disclosure may be different depending on the Calorie level of a particular container.

In various embodiments, the present disclosure may provide a multi-day dietary system or meal plan. For example, in various embodiments, the containers 10 may be provided for a daily meal plan, a two day meal plan, a weekly meal plan, a monthly meal plan, or meal plan for any other suitable time frame.

In various embodiments, the predetermined daily meal plans may comprise variations of one or more macro nutrients within each Calorie level. In one embodiment, the macro nutrients may comprise protein, carbohydrate, fat, and/or dietary fiber. The daily allotment of protein may be increased while the daily allotment of carbohydrates may be decreased. In another embodiment, the daily allotment of fat may be increased while the daily allotment of carbohydrates may be decreased. In one embodiment, the daily allotment of carbohydrates may be increased while either the daily allotment of fat or protein may be decreased. In another embodiment, the daily allotment of carbohydrates may be increased while the daily allotment of either fat or protein may be increased.

In various embodiments, the proportions of macro nutrients comprising protein, carbohydrate, fat, and/or dietary fiber provided in the edible components of the individually prepackaged containers 12 may be increased or decreased to compensate for a life activity. For example, a cardio or aerobic formula may be provided in certain embodiments such that the daily allotment of one or more meals provides a greater percentage of the daily allotment of caloric intake of the nutritional components of protein, fat, and/or carbohydrate to energize or otherwise prepare the body prior to aerobic or cardio exercise or to replenish and/or otherwise aid in the recovery of the body following the same. In one embodiment, a muscle formula specifically targeting individuals involved in muscle building and/or muscle depleting activities may be provided. This formula may provide an increased daily allotment or increased percentage of daily allotment in certain meals of the nutritional components of protein, fat, or carbohydrate to energize or otherwise prepare the body prior to the muscle building or muscle depleting activity and/or to replenish and/or otherwise aid in the recovery of the body following the same.

All documents cited in the Detailed Description are, in relevant part, incorporated herein by reference in their entirety. The citation of any document is not to be construed as an admission that it is prior art with respect to the present disclosure. To the extent that any meaning or definition of a term in the present disclosure conflicts with any meaning or definition of the term in a document incorporated by reference, the meaning or definition assigned to the term in the present disclosure document shall govern.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 inches” is intended to mean “about 40 inches.”

While particular non-limiting embodiments of the present disclosure have been illustrated and described, those of skill in the art will recognize that various other changes and modifications may be made without departing from the spirit and scope of the present disclosure. It is therefore intended to cover in the appended claims all such changes and modifications that are within the scope of the present disclosure.

What is claimed is:

1. A container for a prepackaged dietary daily meal plan, the container, comprising:
a hollow body portion; and
individually prepackaged containers configured to be received within the hollow body portion, each of the individually prepackaged containers comprising an edible component of a dietary daily meal plan, the edible components each having a predetermined caloric content, wherein the edible components together provide a predetermined daily caloric content (E) when consumed;
wherein the individually prepackaged containers comprise:
a first individually prepackaged container comprising a first edible component having a first caloric content (A);
a second individually prepackaged container comprising a second edible component having a second caloric content (B);
a third individually prepackaged container comprising a third edible component having a third caloric content (C); and
a fourth individually prepackaged container comprising a fourth edible component having a fourth caloric content (D); and
wherein the predetermined daily caloric content (E) is determined by the following relationship:
E≧A+B+C+D.

2. The container for a prepackaged dietary daily meal plan of claim 1, comprising:
an indicia located on the individually prepackaged containers to indicate the caloric content of the edible component contained therein; and
an indicia located on an outer portion of the hollow body portion to indicate the caloric content of each of the edible components.

3. The container for a prepackaged dietary daily meal plan of claim 1, comprising at least one aperture along a longitudinal length of the hollow body portion.

4. The container for a prepackaged dietary daily meal plan of claim 1, wherein the individually prepackaged containers comprise a fifth individually prepackaged container comprising a fifth edible component having a fifth caloric content (F), wherein the predetermined daily caloric content (E) is the sum of the first, second, third, fourth, and fifth caloric contents of the corresponding first, second, third, fourth, and fifth edible components contained in the corresponding first, second, third, fourth, and fifth individually prepackaged containers, and wherein the predetermined daily caloric content (E) is determined by the following relationship:
E=A+B+C+D+F.

5. The container for a prepackaged dietary daily meal plan of claim 4, wherein:
the first edible component of the first individually prepackaged container comprises breakfast;
the second edible component of the second individually prepackaged container comprises an early lunch;
the third edible component of the third individually prepackaged container comprises a late lunch;
the fourth edible component of the fourth individually prepackaged container comprises dinner; and
the fifth edible component of the fifth individually prepackaged container comprises a snack.

6. The container for a prepackaged dietary daily meal plan of claim 4, wherein:
the first caloric content (A) of the first edible component is about 25% of the predetermined daily caloric content (E);
the second caloric content (B) of the second edible component is about 18% of the predetermined daily caloric content (E);
the third caloric content (C) of the third edible component is about 27% of the predetermined daily caloric content (E);
the fourth caloric content (D) of the fourth edible component is about 25% of the predetermined daily caloric content (E); and
the fifth caloric content (F) of the fifth edible component is about 5% of the predetermined daily caloric content (E).

7. The container for a prepackaged dietary daily meal plan of claim 4, wherein the sum of the first caloric content (A) of the first edible component and the fourth caloric content (D) of the fourth edible component is about equal to the sum of the second caloric content (B) of the second edible component, the third caloric content (C) of the third edible component, and the fifth caloric content (F) of the fifth edible component.

8. The container for a prepackaged dietary daily meal plan of claim 4, wherein the sum the second caloric content (B) of the second edible component and the fourth caloric content (D) of the fourth edible component is less than the sum of the first caloric content (A) of the first edible component and the third caloric content (C) of the third edible component.

9. The container for a prepackaged dietary daily meal plan of claim 4, wherein the sum of the first caloric content (A) of the first edible component and the second caloric content (B) of the second edible component is between about 36% and about 49% of the predetermined daily caloric content (E).

10. The container for a prepackaged dietary daily meal plan of claim 4, wherein the predetermined daily caloric content (E) divided by the sum of grams of fat in the edible components is between about 29 and about 41.

11. The container for a prepackaged dietary daily meal plan of claim 4, wherein the predetermined daily caloric content (E) divided by the sum of grams of carbohydrates in the edible components is between about 7.4 and about 8.2.

12. The container for a prepackaged dietary daily meal plan of claim 4, wherein the predetermined daily caloric content (E) is one of:
about 1,150 Calories to about 1,250 Calories;
about 1,525 Calories to about 1,675 Calories;
about 1,900 Calories to about 2,100 Calories; and
about 2,275 Calories to about 2,525 Calories.

13. The container for a prepackaged dietary daily meal plan of claim 12, wherein the edible components of the individually prepackaged containers comprise micro nutrients, wherein the micro nutrients comprise potassium, cholesterol, essential fat omega-3, calcium, chromium, copper, fluoride, iodine, iron, magnesium, manganese, molybdenum, phosphorous, selenium, zinc, vitamin A, vitamin B1, vitamin B1, vitamin B3, vitamin B6, vitamin B12, biotin, vitamin C, vitamin D, vitamin E, folate, vitamin K, and pantothenic acid, and wherein the amount of micro nutrients in the first, second, third, fourth, and fifth individually prepackaged containers is about the same at all values of the predetermined daily caloric content E.

14. The container for a prepackaged dietary daily meal plan of claim 1, wherein the hollow body portion comprises:
a first side wall;
a second side wall; and
a third side wall;
wherein the indicia to indicate the caloric content of each of the edible components is provided on the first side wall, the second side wall, and the third side wall.

15. The container for a prepackaged dietary daily meal plan of claim 1, wherein the hollow body portion comprises:
a first end portion;
a second end portion;
a first side portion;
a second side portion; and
a third side portion;
wherein indicia to indicate the sum of the caloric content of the edible components is provided on the first end portion, the second end portion, the first side portion, the second side portion, and the third side portion.

16. A dietary daily meal plan prepackaged in a container comprising a hollow body portion comprising at least one aperture along a longitudinal length thereof, the dietary daily meal plan, comprising:
a plurality of individually prepackaged containers, each of the individually prepackaged containers comprising an edible component of a dietary daily meal plan, the edible components each having a predetermined nutritional content of a nutrient component, wherein the edible components of each of the individually prepackaged containers together provide a predetermined daily nutritional content (E) of the nutrient component when consumed;
wherein the individually prepackaged containers comprise:
a first individually prepackaged container comprising a first edible component having a first nutritional content (A) of the nutrient component;
a second individually prepackaged container comprising a second edible component having a second nutritional content (B) of the nutrient component;
a third individually prepackaged container comprising a third edible component having a third nutritional content (C) of the nutrient component;
a fourth individually prepackaged container comprising a fourth edible component having a fourth nutritional content (D) of the nutrient component; and
a fifth individually prepackaged container comprising a fifth edible component having a fifth nutritional content (F) of the nutrient component;
wherein the predetermined daily nutritional content (E) of the nutrient component is the sum of the first, second, third, fourth, and fifth nutritional contents (A, B, C, D, and F) of the nutrient component of the corresponding first, second, third, fourth, and fifth edible components contained in the corresponding first, second, third, fourth, and fifth individually prepackaged containers;
wherein the predetermined daily nutritional content (E) of the nutrient component is determined by the following relationship:
E=A+B+C+D+F.

17. The daily dietary meal plan of claim 16, wherein the nutrient component is protein, wherein the nutritional content of protein in each of the edible components is represented as a percentage of the predetermined daily nutritional content of protein, and wherein the first nutritional content (A) of the nutrient component is about 20% of the predetermined daily nutritional content of protein, the second nutritional content (B) of the nutrient component is about 30% of the predetermined daily nutritional content of protein, the third nutritional content (C) of the nutrient component is about 30% of the predetermined daily nutritional content of protein, the fourth nutritional content (D) of the nutrient component is about 20% of the predetermined daily nutritional content of protein, and the fifth nutritional content (F) of the nutrient component is about 5% of the predetermined daily nutritional content of protein.

18. The daily dietary meal plan of claim 16, wherein the nutrient component is protein, and wherein the sum of the nutrient components of the first, fourth, and fifth edible components is less than the sum of the nutrient components of the second and third edible components.

19. The daily dietary meal plan of claim 16, wherein the nutrient component is fat, wherein the nutritional content of fat in each of the edible components is expressed as a percentage of the predetermined daily nutritional content of fat, and wherein the first nutritional content (A) of the nutrient component is about 25% of the predetermined daily nutritional content of fat, the second nutritional content (B) of the nutrient component is about 16% of the predetermined daily nutritional content of fat, the third nutritional content (C) of the nutrient component is about 28% of the predetermined daily nutritional content of fat, the fourth nutritional content (D) of the nutrient component is about 25% of the predetermined daily nutritional content of fat, and the fifth nutritional content (F) of the nutrient component is about 5% of the predetermined daily nutritional content of fat.

20. The daily dietary meal plan of claim 16, wherein the nutrient component is saturated fat, wherein the nutritional content of saturated fat in each of the edible components is represented as a percentage of the predetermined daily nutritional content of saturated fat, and wherein the first nutritional content (A) of the nutrient component is about 24% of the predetermined daily nutritional content of saturated fat, the second nutritional content (B) of the nutrient component is about 19% of the predetermined daily nutritional content of saturated fat, the third nutritional content (C) of the nutrient component is about 27% of the predetermined daily nutritional content of saturated fat, the fourth nutritional content (D) of the nutrient component is about 24% of the predetermined daily nutritional content of saturated fat, and the fifth nutritional content (F) of the nutrient component is about 8% of the predetermined daily nutritional content of saturated fat.

21. The daily dietary meal plan of claim 16, wherein the nutrient component is carbohydrates, wherein the nutritional content of carbohydrates in each of the edible components is represented as a percentage of the predetermined daily nutritional content of carbohydrates, and wherein the first nutritional content (A) of the nutrient component is about 25% of the predetermined daily nutritional content of carbohydrates, the second nutritional content (B) of the nutrient component is about 17% of the predetermined daily nutritional content of carbohydrates, the third nutritional content (C) of the nutrient component is about 27% of the predetermined daily nutritional content of carbohydrates, the fourth nutritional content (D) of the nutrient component is about 25% of the predetermined daily nutritional content of carbohydrates, and the fifth nutritional content (F) of the nutrient component is about 5% of the predetermined daily nutritional content of carbohydrates.

22. The daily dietary meal plan of claim 16, wherein the nutrient component is fiber, wherein the nutritional content of fiber in each of the edible components is represented as a percentage of the predetermined daily nutritional content of fiber, and wherein the first nutritional content (A) of the nutrient component is about 24% of the predetermined daily nutritional content of fiber, the second nutritional content (B) of the nutrient component is about 17% of the predetermined daily nutritional content of fiber, the third nutritional content (C) of the nutrient component is about 25% of the predetermined daily nutritional content of fiber, the fourth nutritional content (D) of the nutrient component is about 24% of the predetermined daily nutritional content of fiber, and the fifth nutritional content (F) of the nutrient component is about 10% of the predetermined daily nutritional content of fiber.

23. A container for a prepackaged daily meal plan, the container, comprising:
a hollow body portion; and
a plurality of prepackaged containers each comprising edible content therein, wherein the prepackaged containers are positioned within the hollow body portion, and wherein each of the prepackaged containers comprise indicia to indicate the nutritional and caloric content of the edible content contained therein;
wherein the hollow body portion comprises at least one aperture along a longitudinal length thereof, wherein the aperture comprises:
a first end;
a second end;
a first side wall extending between the first end and the second end;
a second side wall extending between the first end and the second end;
a longitudinal axis defined between the first end and the second end;
a lateral axis defined between a midpoint of the first side wall and a midpoint of the second side wall;
a first quadrant defined on a first side of the longitudinal axis and a first side of the lateral axis;
a second quadrant defined on the first side of the longitudinal axis and a second side of the lateral axis;
a third quadrant defined on a second side of the longitudinal axis and the first side of the lateral axis;
a fourth quadrant defined on the second side of the longitudinal axis and the second side of the lateral axis;
a first arcuate portion forming a portion of the aperture in the first quadrant;
a second arcuate portion forming a portion of the aperture in the second quadrant;
a third arcuate portion forming a portion of the aperture in the third quadrant; and
a fourth arcuate portion forming a portion of the aperture in the fourth quadrant.

24. The container for a prepackaged daily meal plan of claim 23, wherein at least one of the prepackaged containers is exposed through the at least one aperture.

25. The container for a prepackaged daily meal plan of claim 23, wherein the at least one aperture comprises:
a first aperture; and
a second aperture;
wherein the first aperture forms a portion of a first corner of the hollow body portion;
wherein the second aperture forms a portion of a second corner of the hollow body portion; and
wherein the first corner is positioned adjacent to the second corner.

26. The container for a prepackaged daily meal plan of claim 23, comprising a second aperture substantially similar to the first aperture, wherein the first aperture and the second aperture are at least partially defined in a back wall of the hollow body portion.
